(19) United States
(12) Patent Application Publication
(10) Pub. No.: US 2021/0375052 A1
(43) Pub. Date: Dec. 2, 2021

(54) INFORMATION PROCESSOR, INFORMATION PROCESSING METHOD, AND PROGRAM

(71) Applicant: SONY CORPORATION, TOKYO (JP)

(72) Inventors: TSUYOSHI ABIKO, SAITAMA (JP); YASUHIDE HOSODA, KANAGAWA (JP)

(21) Appl. No.: 16/956,724

(22) PCT Filed: Nov. 13, 2018
(86) PCT No.: PCT/JP2018/041933

§ 371 Date: Jun. 22, 2020

(30) Foreign Application Priority Data
Dec. 28, 2017 (JP) 2017-253804

(51) Int. Cl. G06T 19/00; G06T 15/00; G06T 19/20; G06T 15/20; G06T 7/70; A63F 13/216; A63F 13/35; A63F 13/5378; A63F 13/65; A63F 13/63; A63F 13/5255

(52) U.S. Cl. CPC G06T 19/006; G06T 15/00; G06T 19/20; G06T 15/20; G06T 7/70; H04W 4/029; A63F 13/35; A63F 13/5378; A63F 13/65; A63F 13/63; A63F 13/5255; A63F 13/216

(57) ABSTRACT

[Overview] [Problem to be Solved] To make it possible to raise an interest in contents provided outside of home. [Solution] There is provided an information processor including: an acquisition unit that acquires content information including image information of a virtual object and position information of the virtual object in real space, the content information to be added to map information representing the real space; and a first control unit that displays, on a basis of the content information, the image information on a first client terminal at a position in virtual space corresponding to the position information to superimpose the image information on an image in the virtual space that is visible in a first-person view.

### TECHNICAL FIELD

The present disclosure relates to an information processor, an information processing method, and a program.

### BACKGROUND ART

In recent years, various technologies for providing users with contents such as games have been developed with the progress of information processing technologies. For example, the following PTL 1 discloses a technology in which items and the like related to a game playable by a game device at home and the like are acquirable in accordance with the position of a mobile terminal device when going out by logging in from the mobile terminal device to a game server. In addition, a technology for reflecting thus-acquired items and the like in the game executed by the game device at home and the like is also disclosed. These technologies raise a user's interest in the game and provide a more highly entertaining game.

### CITATION LIST

### Patent Literature

PTL 1: Japanese Unexamined Patent Application Publication No. 2016-087017

### SUMMARY OF THE INVENTION

### Problems to be Solved by the Invention

However, the technology disclosed in PTL 1 mainly raises an interest in a game played at home and the like by a user, and does not raise an interest in a game played outside of home by the user. Accordingly, there is still room for improvement in raising an interest in contents provided outside of home.

The present disclosure has been made in view of the above-described issue, and an object of the present invention is to provide novel and improved information processor, information processing method, and program that make it possible to raise a user's interest in contents such as games provided outside of home.

### Means for Solving the Problems

According to the present disclosure, there is provided an information processor including: an acquisition unit that acquires content information including image information of a virtual object and position information of the virtual object in real space, the content information to be added to map information representing the real space; and a first control unit that displays, on the basis of the content information, the image information on a first client terminal at a position in virtual space corresponding to the position information to superimpose the image information on an image in the virtual space that is visible in a first-person view.

In addition, according to the present disclosure, there is provided an information processing method to be executed by a computer, the information processing method including: acquiring content information including image information of a virtual object and position information of the virtual object in real space, the content information to be added to map information representing the real space; and displaying, on the basis of the content information, the image information on a first client terminal at a position in virtual space corresponding to the position information to superimpose the image information on an image in the virtual space that is visible in a first-person view.

In addition, there is provided a program causing a computer to execute: acquiring content information including image information of a virtual object and position information of the virtual object in real space, the content information to be added to map information representing the real space; and displaying, on the basis of the content information, the image information on a first client terminal at a position in virtual space corresponding to the position information to superimpose the image information on an image in the virtual space that is visible in a first-person view.

### Effect of the Invention

As described above, according to the present disclosure, it is possible to raise an interest in contents provided outside of home.

It should be noted that the effects described above are not necessarily limitative. Any of the effects indicated in this description or other effects that may be understood from this description may be exerted in addition to the effects described above or in place of the effects described above.

### BRIEF DESCRIPTION OF DRAWING

FIG. 1 is a diagram illustrating a system configuration example of an information processing system according to the present embodiment.

FIG. 2 is a diagram illustrating an example of a client 200.

FIG. 3 is a diagram illustrating an example of the client 200.

FIG. 4 is a diagram illustrating an example of the client 200.

FIG. 5 is a block diagram illustrating a functional configuration example of a server 100.

FIG. 6 is a diagram illustrating an example of a GUI screen used for creation of contents.

FIG. 7 is a diagram illustrating an example of the GUI screen used for creation of contents.

FIG. 8 is a diagram illustrating an example of the GUI screen used for creation of contents.

FIG. 9 is a diagram illustrating an example of the GUI screen used for creation of contents.

FIG. 10 is a diagram illustrating an example of the GUI screen used for creation of contents.

FIG. 11 is a diagram for describing a display example of an AR content.

FIG. 12 is a diagram for describing a display example of a VR content.

FIG. 13 is a block diagram illustrating a functional configuration example of the client 200.

FIG. 14 is a flowchart illustrating an example of a processing flow related to provision of a content.

FIG. 15 is a flowchart illustrating an example of a processing flow related to provision of the content.

FIG. 16 is a block diagram illustrating a hardware configuration example of an information processor 900 embodying the server 100 or the client 200.

FIG. 17 is a diagram illustrating a content provision example according to a first example.

FIG. 18 is a diagram illustrating a content provision example according to the first example.

FIG. 19 is a diagram illustrating a content provision example according to the first example.

FIG. 20 is a diagram illustrating a content provision example according to a second example.

### MODES FOR CARRYING OUT THE INVENTION

A preferred embodiment of the present disclosure is described below in detail with reference to the accompanying drawings. It should be noted that, in this description and the accompanying drawings, components that have substantially the same functional configuration are denoted by the same reference numerals, and thus redundant description thereof is omitted.

It should be noted that the description is given in the following order.
1. Embodiment
1.1. Overview
1.2. System Configuration Example
1.3. Functional Configuration Example of Server 100
1.4. Functional Configuration Example of Client 200
1.5. Example of Processing Flow
1.6. Hardware Configuration Example
2. Examples
2.1. First Example
2.2. Second Example
2.3. Third Example
2.4. Modification Example
3. Conclusion

### 1. Embodiment

### 1.1. Overview

First, description is given of an overview of an embodiment according to the present disclosure.

As described above, various technologies for providing users with contents such as games have been developed along with the progress of information processing technologies. However, there is still room for improvement in raising a user's interest in contents provided outside of home.

Therefore, in view of this circumstance, the discloser of the present application has devised the technology of the present application. The present disclosure makes it possible to provide a platform where a VR (Virtual Reality) content is available with use of at least a portion of information used for provision of an AR (Augmented Reality) content.

More specifically, an information processor (server 100) according to the present disclosure makes it possible to create a VR content with use of at least a portion of information used for provision of a AR content. Thereafter, the information processor is able to provide a user device (client 200) with the thus-created VR content. It should be noted that the information processor is also able to create an AR content and is also able to provide the user device with the thus-created AR content. In the present disclosure, the AR content may be considered as a content to be provided outdoors, and the VR content may be considered as a content to be provided indoors. It should be noted that in a case where a content is a content to be provided with use of indoor space having a larger area, such as a commercial facility or a building, than a typical private house, the content may be considered as an AR content. That is, the AR content may be considered as a content in which movement of the position of a user in real space corresponds to movement of the position of the user in the AR content on a one-to-one basis. Meanwhile, the VR content may be considered as a content in which the position of the user in the VR content is freely movable independently of the movement of the position of the user in real space.

Thus, according to the present disclosure, making the user experience the VR content corresponding to the AR content makes it possible to raise a user's interest in the AR content that is originally experienceable only on-site and to more efficiently spread the AR content.

It should be noted that the AR content according to the present embodiment refers to a content that is allowed to display a virtual object on an image in real space in a superimposed manner, and the VR content refers to a content that is allowed to display an virtual object on an image in virtual space in a superimposed manner (or a content in which an entire display screen is configured using a virtual object). The AR content or the VR content may simply be referred to as “content” or “these contents”. It should be noted that the “image in real space” in the present disclosure may encompass a composite image generated on the basis of a real space image acquired by capturing real space. That is, the composite image may include a depth image having depth information corresponding to real space based on a result of analysis the real space image, a corrected image processed on the basis of a tone (appearance information such as a color, contrast, and brightness) of a virtual object, and the like. Meanwhile, the “image in virtual space” may be understood as an image created without referring to information of real space.

### 1.2. System Configuration Example

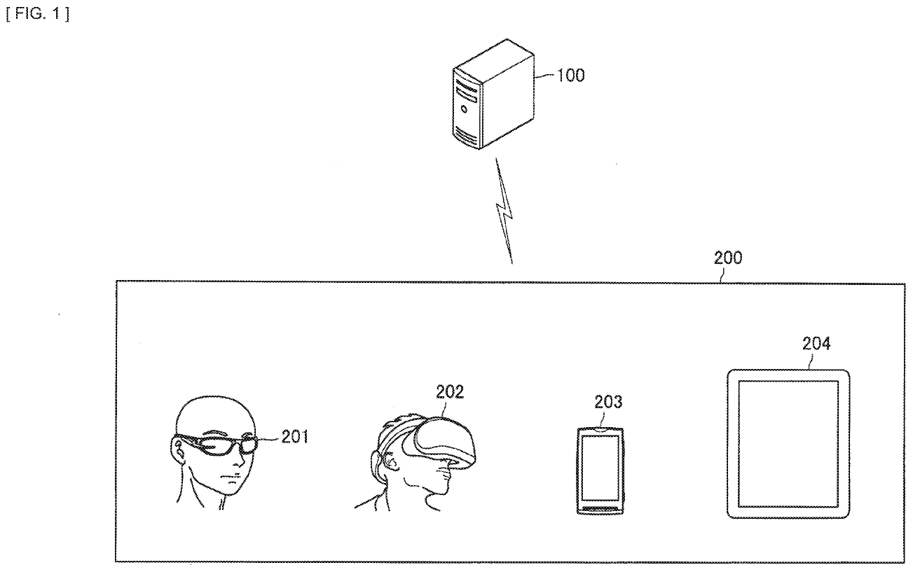

The overview of the embodiment of the present disclosure has been described above. Next, a configuration example of an information processing system according to the present embodiment is described with reference to FIGS. 1 to 4.

As illustrated in FIG. 1, the information processing system according to the present embodiment includes the server 100 and the client 200.

### Server 100

The server 100 is an information processor that is able to create an AR content and a VR content and provide the client 200 with these contents. Creation of the contents is more specifically described. The server 100 provides a user with a development platform where it is possible to create an AR content and a VR content. For example, the server 100 provides the client 200 with a GUI (Graphical User Interface) screen where it is possible to create these contents. The user then performs various inputs to the GUI screen, which makes it possible to create content information to be used for an AR content. The content information includes image information of a virtual object, position information of the virtual object in real space, and the like. Further, it is also possible for the user to create content information to be used for a VR content with use of at least a portion of the virtual object.

In addition, provision of contents is more specifically described. The server 100 determines whether to provide an AR content or a VR content on the basis of position information of the user in real space and property information of the client 200. For example, in a case where the position information of the user indicates “home” and the property information of the client 200 indicates “stationary terminal (non-AR compatible terminal)”, the server 100 provides the client 200 with the VR content. In addition, in a case where the position information of the user indicates a specific position in real space and the property information of the client 200 indicates “AR-compatible terminal”, the server 100 provides the client 200 with the AR content. Here, the property information of the client 200 refers to any information regarding the client 200 including product information, setting information, or the like of the client 200. It should be noted that the above description is merely an example, and a method of controlling provision of contents by the server 100 may be changed as appropriate. For example, in a case where the client 200 is a mobile terminal, the server 100 may be controlled to provide the VR content if the position information of a user of the mobile terminal indicates “outside an AR content area”, and to provide the AR content if the position information of the user of the mobile terminal indicates “inside the AR content area”. In addition, the server 100 may present, to the mobile terminal, an icon indicating which of the AR content and the VR content is playable for the same content.

Here, a communication method between the server 100 and the client 200 is not specifically limited. For example, a network that couples the server 100 and the client 200 to each other may be either a wired transmission path or a wireless transmission path. Examples of the network may include a public network such as the Internet, various LANs (Local Area Networks) including Ethernet (registered trademark), various WANs (Wide Area Networks), and the like. In addition, the network may also include a leased line network such as IP-VPN (Internet Protocol-Virtual Private Network), or a short-range wireless communication network such as Bluetooth (registered trademark).

In addition, the type of the server 100 is not specifically limited, and may be any information processor including, for example, a general-purpose computer, a desktop PC (Personal Computer), a notebook PC, a tablet-type PC, a smartphone, and the like.

### Client 200

The client 200 is an information processor to be used by a user when creating an AR content and a VR content or when reproducing these contents. Creation of the contents is more specifically described. The client 200 displays the GUI screen provided by the server 100. The user is allowed to set information necessary for creation of the contents (for example, image information of a virtual object, position information of the virtual object in real space, event information by the virtual object, and the like) with use of the GUI screen. The client 200 provides the server 100 with input information from the user, thereby achieving creation of these contents.

Reproduction of contents is more specifically described. The client 200 provides the server 100 with the position information of the user and the property information of the client 200. The client 200 then receives content information provided by the server 100 on the basis of these pieces of information and outputs the information by a predetermined method, thereby providing the user with these contents. It should be noted that a method of outputting the contents by the client 200 is not specifically limited. For example, the client 200 may display the contents on a display or the like, or may pronounce the contents from a speaker or the like. In addition, information provided from the client 200 to the server 100 in a case where the contents are reproduced is not limited to the information described above.

In addition, as illustrated in FIG. 1, the client 200 includes a variety of devices. Examples of the client 200 include an optical see-through head-mounted display 201 (hereinafter referred to as “HMD”), an occlusive (or video see-through) HMD 202, a smartphone 203, a tablet-type PC 204, or the like. The optical see-through HMD 201, the video see-through HMD 202, the smartphone 203, the tablet-type PC 204, or the like is intended to be used for reproduction of the AR content, and the occlusive HMD 202, the smartphone 203, the tablet-type PC 204, or the like is intended to be used for reproduction of the VR content, but these are not limitative. It should be noted that the client 200 may include any display device other than these display devices. For example, the client 200 may include a television, and the like.

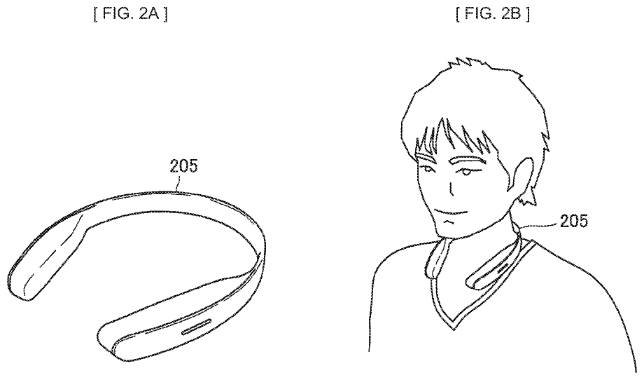

In addition, the client 200 may include any information processor that does not have a displaying function. For example, as illustrated in 2A and 2B of FIG. 2, the client 200 may include a speaker 205 without covering ears (hereinafter referred to as an “open ear speaker”). As illustrated in 2B, the open ear speaker 205 is used while being put on the neck of the user and does not cover the ears, thereby not blocking ambient sounds. Accordingly, in a case where a content (specifically an AR content) is to be reproduced, the open ear speaker 205 localizes a sound image to superimpose the sound image on sounds in real space, which makes it possible to perform an acoustic output with a sense of reality.

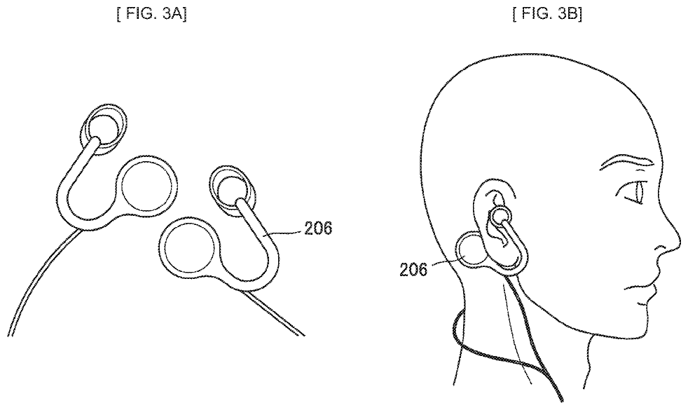

In addition, the client 200 may also include an open ear speaker 206 as illustrated in 3A and 3B of FIG. 3. The open ear speaker 206 is worn by being inserted into an ear of the user, as illustrated in 3B, but has a through hole in a portion inserted into the ear, thereby not covering the ears and not blocking ambient sounds. Accordingly, in a case where a content (specifically an AR content) is to be reproduced, the open ear speaker 206 also localizes a sound image to superimpose the sound image on sounds in real space, which makes it possible to perform an acoustic output with a sense of reality.

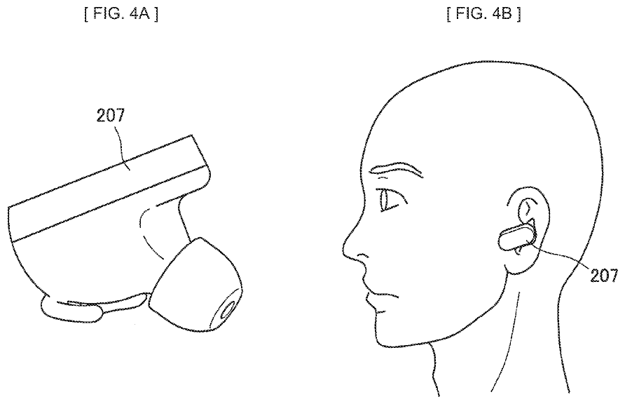

In addition, the client 200 may also include a wearable terminal 207 illustrated in 4A and 4B of FIG. 4. As illustrated in 4B, the wearable terminal 207 is a device worn on an ear of the user, and localizes a sound image, thereby making it possible to perform an acoustic output with a sense of reality. The wearable terminal 207 is provided with various sensors, and is a device that is allowed to estimate a posture (for example, inclination of a head, and the like), speech, a position, an action, and the like of the user on the basis of sensor information from these sensors.

### 1.3. Functional Configuration Example of Server 100

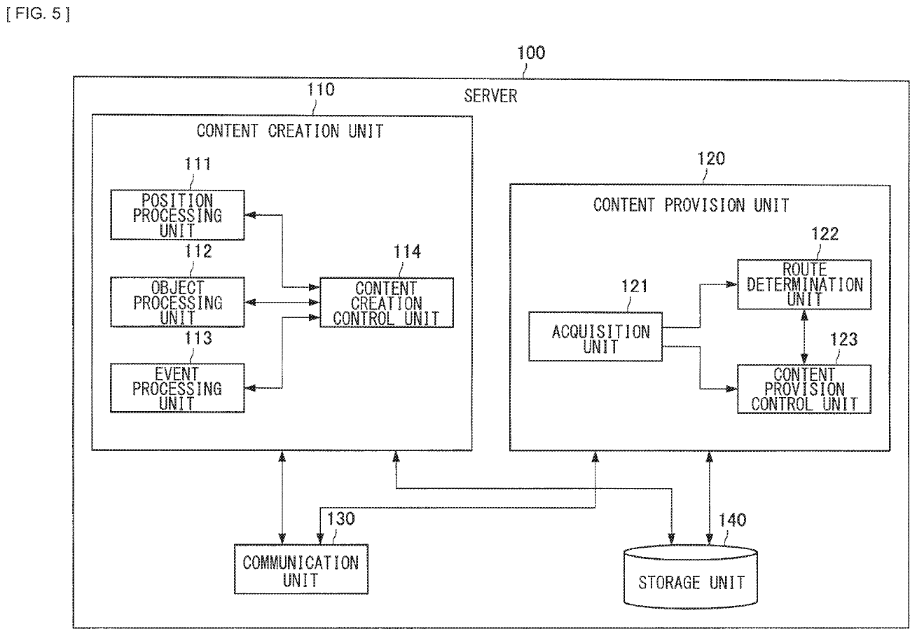

The system configuration example of the information processing system according to the present embodiment has been described above. Next, a functional configuration example of the server 100 is described below with reference to FIG. 5.

As illustrated in FIG. 5, the server 100 includes a content creation unit 110, a content provision unit 120, a communication unit 130, and a storage unit 140.

### Content Creation Unit 110

The content creation unit 110 is a functional configuration that creates an AR content or a VR content. As illustrated in FIG. 5, the content creation unit 110 includes a position processing unit 111, an object processing unit 112, an event processing unit 113, and a content creation control unit 114.

The position processing unit 111 is a functional configuration that performs processing related to position information of a virtual object in the AR content or the VR content. More specifically, in creation of these contents, the position processing unit 111 sets position information of the virtual object in real space on the basis of an input from the user. The position information here includes, for example, latitude information and longitude information. The position processing unit 111 sets the latitude information and the longitude information as the position information of the virtual object, thereby making it possible to display the virtual object at a position in real space corresponding to the position information for the AR content, and making it possible to display the virtual object at a position in virtual space corresponding to the position information for the VR content.

It should be noted that details of the position information are not limited to the above. For example, the position information may include altitude information. The position processing unit 111 sets the altitude information as the position information of the virtual object, thereby making it possible to display the virtual object at a position having the same latitude and the same longitude but a different altitude. Such a configuration makes it possible to display a virtual object group different for each of planes of respective floors of a building, for example. In addition, the position information may also include some information indicating a position, a region, a building, or the like in real space, such as address information, spot name information, or spot code information. In addition, the position information may also include information regarding orientation or posture of the virtual object.

The object processing unit 112 is a functional configuration that performs processing related to the virtual object in the AR content or the VR content. More specifically, the object processing unit 112 sets virtual object information including image information of the virtual object on the basis of an input from the user. For example, the object processing unit 112 manages image information of a plurality of virtual objects, and may allow the user to select image information of a virtual object to be used for the content from the image information of the virtual objects. In addition, the object processing unit 112 may collect image information scattered on an external network (for example, the Internet) and allow the user to select image information to be used for the content from these pieces of image information. In addition, the object processing unit 112 may use image information inputted by the user for the content.

It should be noted that details of the image information of the virtual object are not specifically limited. For example, the image information of the virtual object may include some illustration information (or animation information), or may include still image information (or moving image information) of an object existing in real space.

The event processing unit 113 is a functional configuration that performs processing related to an event to be performed by the virtual object in the AR content or the VR content. More specifically, the event processing unit 113 sets event information including details and an occurrence condition of the event on the basis of an input from the user. Here, the event includes, but is not limited to, any action to be performed by one or two or more virtual objects, an event to be performed at a specific place, or an event that occurs by an action or the like of the virtual object. In addition, the details of the event includes, but is not limited to, a virtual object that is to perform the event, a position where the event is to be performed, a timing at which the event is to be performed, a purpose of the event, a method of executing the event, and the like. In addition, the occurrence condition of the event is specified by a date and time, a place, an action or status of the user or the virtual object, and the like, and may be specified by any factors other than these factors.

The content creation control unit 114 is a functional configuration that controls creation of the AR content or the VR content. More specifically, the content creation control unit 114 provides the client 200 with a GUI screen used for creation (or edition, etc.) of these contents.

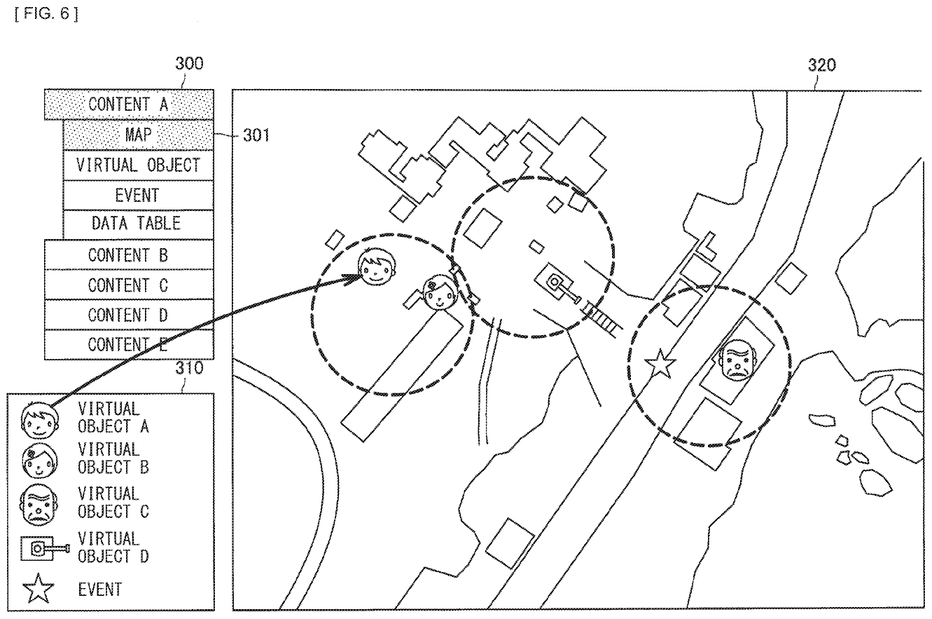

Hereinafter, description is given of an example of the GUI screen provided from the content creation control unit 114 to the client 200 (client terminal) with reference to FIGS. 6 to 10. It should be noted that data related to the GUI screen may be temporarily used offline by the client 200, and the data related to the GUI screen may be managed distributively by the server 100 and the client 200. FIG. 6 illustrates an example of a GUI screen used for creation of position information. As illustrated in FIG. 6, content tabs 300 that manage content information regarding a plurality of contents (contents A to E in FIG. 6) are displayed on the GUI screen, and the user selects the content tab 300 with use of the client 200 to specify a content to be created (or edited).

In a case where the user selects the content tab 300, the content tab 300 is expanded to display a map tab 301. It should be noted that, although not illustrated in FIG. 6, a plurality of pieces of map information may be used for each content, and in a case where a plurality of pieces of map information is used, a plurality of map tabs 301 may be displayed (the plurality of pieces of map information here may be generated by dividing a single piece of map information, or may be a plurality of pieces of map information different from each other). Thereafter, in a case where the user selects the map tab 301, the content creation control unit 114 displays a virtual object selection region 310 and a map display region 320 on the screen. The virtual object selection region 310 is a region where virtual objects and the like placeable on a map (virtual objects A to D in FIG. 6, and an event A are also displayed) are displayed, and the user is allowed to select a virtual object to be placed on the map by a predetermined operation.

The map display region 320 is a region where a map representing real space selected as a stage of the content is displayed, and the user is allowed to display a map of a desired range by upsizing, downsizing, or moving a global map displayed in the map display region 320. Then, the user is allowed to place, in the map display region 320, the virtual object selected from the virtual object selection region 310 by a predetermined operation. It should be noted that details of the predetermined operations for achieving selection of the virtual object from the virtual object selection region 310 and placement of the virtual object in the map display region 320 are not specifically limited. For example, the user may select and place a virtual object by dragging the virtual object in the virtual object selection region 310 and dropping the virtual object to a desired position in the map display region 320. This allows the user to more easily edit position information. The position processing unit 111 generates position information on the basis of placement of the virtual object in the map display region 320.

It should be noted that an icon of the virtual object to be dragged has a predetermined size to secure visibility and operability of the user. For this reason, depending on the scale of the map to be displayed, it may be difficult to place the virtual object at an intended position.

To solve the above-described issue, the user may display a content being created as the VR content in a first-person view, and appropriately adjust the position of the virtual object in accordance with a user operation in the VR content. A result of such adjustment of the position of the virtual object by the user operation in the VR contents is reflected in position information of the virtual object on the map display region 320.

Instead of adjustment in the VR content, the position of the virtual object dragged and dropped in the map display region 320 may be automatically adjusted as appropriate on the basis of road information, partition information, building information, and the like included in the map information. For example, in a case where a person icon that is a dropped virtual object is substantially included in a road region, the position of the person icon is adjusted to be set outside the road region and along the right or left side of the road region. Alternatively, in a case where a furniture icon that is a dropped virtual object is substantially included in a building region, the position of the furniture icon may be set along a wall inside a building. That is, in a case where a combination of a property of the virtual object, a dropped position of the virtual object, and map information corresponding to the dropped position of the virtual object satisfies a predetermined condition, the position of the virtual object may be automatically adjusted on the basis of the map information, and in a case where the combination does not satisfy the predetermined condition, the position of the virtual object may be set to the dropped position by the user. Further, such automatic adjustment may be prohibited in a case where the scale of the displayed map is equal to or larger than a threshold value, and the position of the virtual object may be optionally set in accordance with the dropped position by the user. In a case where the scale of the displayed map is relatively large, the displayed map may have a sufficient size relative to the size of the icon of the virtual object. Accordingly, the user may appropriately operate the dropped position; therefore, in such a case, automatic adjustment of the position of the virtual object may be prohibited as appropriate.

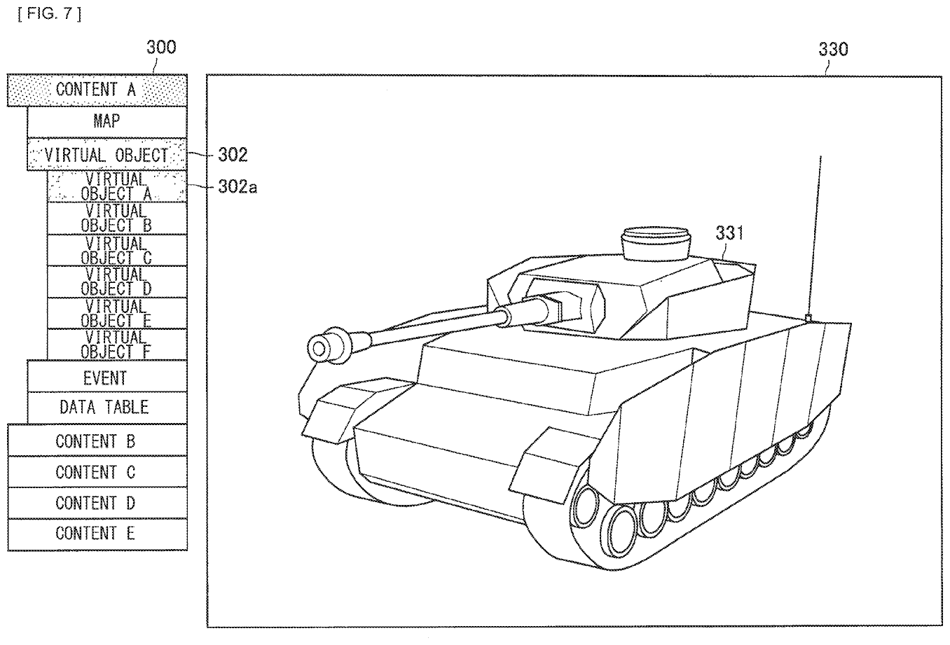

FIG. 7 illustrates an example of a GUI screen used for creation of virtual object information. As illustrated in FIG. 7, in a case where the user selects the content tab 300, the content tab 300 is expanded to display the virtual object tab 302. It should be noted that, as illustrated in FIG. 7, in a case where a plurality of virtual objects is used in the content, the virtual object tab 302 may be further expanded to display a virtual object tab 302a. Thereafter, in a case where the user selects the virtual object tab 302 or the virtual object tab 302a, the content creation control unit 114 displays a virtual object display region 330 on the screen. The virtual object display region 330 is a region where image information 331 of the virtual object selected (or inputted) by the user for use in the content is displayed, and the user is allowed to confirm the image information 331 of the selected virtual object in the virtual object display region 330. It should be noted that, in addition to displaying the image information 331 of the virtual object on the virtual object display region 330, the content creation control unit 114 may provide the user with a function of editing the image information 331 of the virtual object (for example, a function of editing a shape, a pattern, a color, and the like) through the virtual object display region 330. In addition, although not illustrated in FIG. 7, the virtual object information may include sound image information, and confirmation, editing, and the like of the sound image information may be achieved on the GUI screen in FIG. 7. The object processing unit 112 generates the virtual object information on the basis of details of edition performed through the virtual object display region 330.

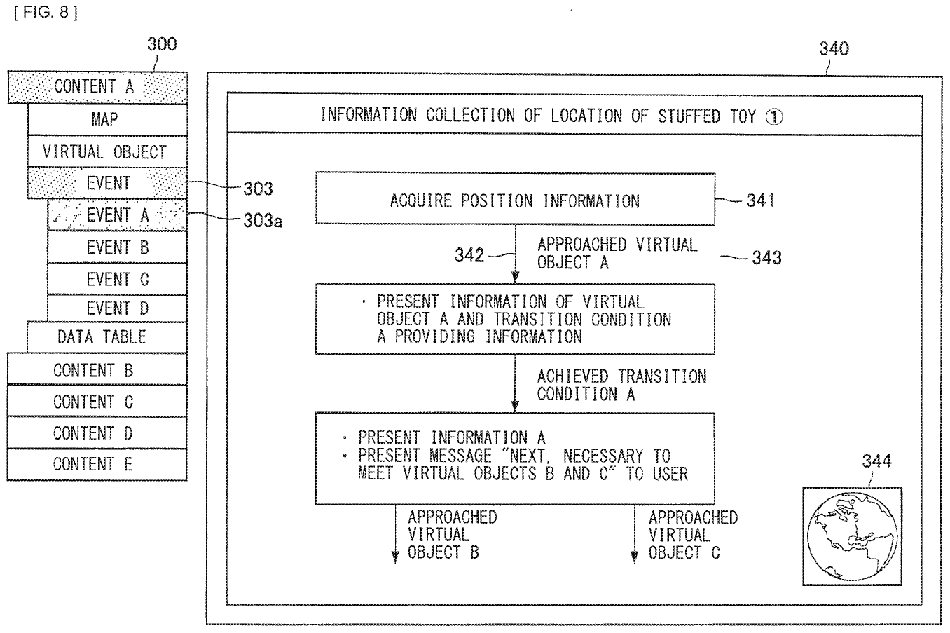

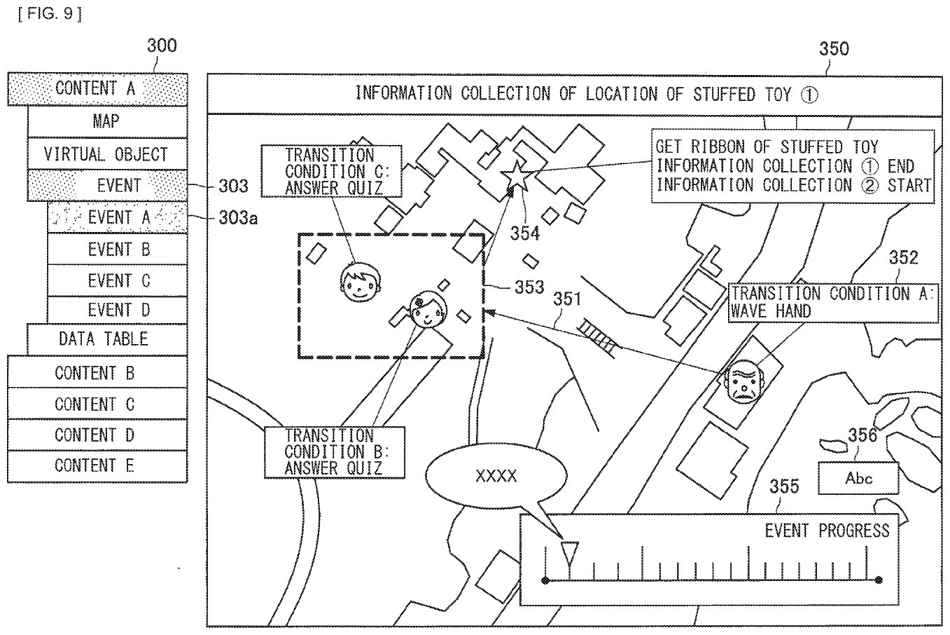

FIGS. 8 and 9 are examples of a GUI screen used for creation of event information. As illustrated in FIG. 8, in a case where the user selects the content tab 300, the content tab 300 is expanded to display an event tab 303. It should be noted that, as illustrated in FIG. 8, in a case where a plurality of events is set in the content, the event tab 303 may be further expanded to display an event tab 303a. Thereafter, in a case where the user selects the event tab 303 or the event tab 303a, the content creation control unit 114 displays an event display region 340 on the screen. The event display region 340 is a region where the user is allowed to edit the event. Edition of the event may be described in unified modelling language (UML (Unified Modeling Language)). For example, a text box 341 or the like is displayed in advance in the event display region 340, and the user is allowed to define processing to be performed in the event, an action of the virtual object, or the like by performing an input to the text box 341. In addition, the user is allowed to define transition of processing and the like in the event with use of an arrow 342, and is allowed to define a condition and the like of the transition with use of a transition condition 343. It should be noted that details illustrated in FIG. 8 are a portion of the entire event, and a work region of the user may be upsized, dragged, or scrolled. In addition, the user is allowed to switch from a screen (text-based screen) illustrated in FIG. 8 to a screen (GUI-based screen) illustrated in FIG. 9 by pressing an icon 344 in the event display region 340.

FIG. 9 is a screen (GUI-based screen) illustrating details corresponding to the event information set in FIG. 8 (the information has been changed as appropriate). In other words, in an event display region 350 in FIG. 9, the event information edited in FIG. 8 is displayed on the map with use of an icon and the like. The arrow 342 and the transition condition 343 in FIG. 8 correspond to an arrow 351 and a transition condition 352 in FIG. 9. In other words, in a case where the transition condition 352 in FIG. 9 is satisfied, processing or the like indicated by the arrow 351 is performed. The user performs clicking, dragging, and the like in the event display region 350, which makes it possible to draw the arrow 351 between virtual objects, or the like. In addition, for example, a dashed line rectangle 353 may be used to cause a plurality of virtual objects to deal with achievement of a transition condition A. In addition, in FIG. 9, a star-shaped object 354 is used as an event delimiter. The user may set the object 354 as the end of a series of events, thereby automatically adding a delimiter in event progress 355 illustrated at the bottom of FIG. 9. The event progress 355 is configured to display stepwise event progress with a slider. Changing the position of the slider makes it possible for the user to display placement of the virtual object in accordance with the event progress on the event display region 350. This makes it possible to easily and visually confirm the event progress. The name of the event or the like is added to the slider as an annotation. In addition, the user presses an icon 356 in the event display region 350, thereby making it possible to switch from the screen (GUI-based screen) illustrated in FIG. 9 to the screen (text-based screen) illustrated in FIG. 8. It should be noted that in regard to the placement of the virtual object, as described with reference to FIG. 6, in a case where the virtual object moves in the event display region 350, the position information of the virtual object is updated, and the position information is managed for each event.

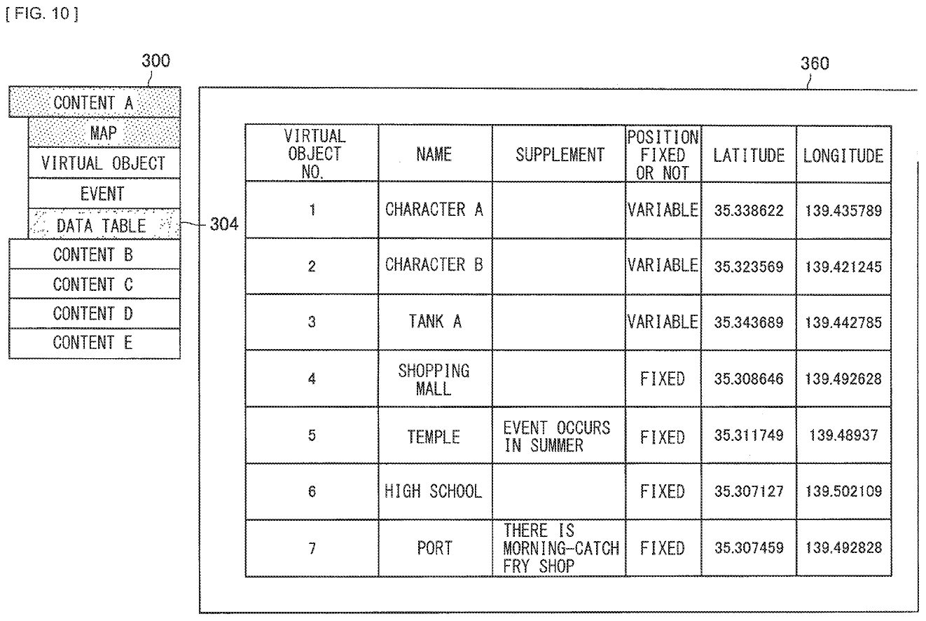

FIG. 10 illustrates an example of a GUI screen used for confirmation and edition of content information including position information, virtual object information, or event information. As illustrated in FIG. 10, in a case where the user selects the content tab 300, the content tab 300 is expanded to display a data table tab 304. A data table representing content information is displayed in a data table display region 360.

It should be noted that “VIRTUAL OBJECT NO.”, “NAME”, and “SUPPLEMENT” included in the virtual object information, and “POSITION FIXED OR NOT”, “LATITUDE”, and “LONGITUDE” included in the position information are represented in the data table. The “VIRTUAL OBJECT NO.” indicates an identifiable number of a virtual object, the “NAME” indicates the name of the virtual object, and the “SUPPLEMENT” indicates supplementary information regarding the virtual object. In addition, the “POSITION FIXED OR NOT” indicates whether the position of the virtual object is fixed or variable, the “LATITUDE” indicates latitude information where the virtual object is placed, and the “LONGITUDE” indicates longitude information where the virtual object is placed. Details displayed in the data table display region 360 are not limited thereto. For example, any information other than the position information, the virtual object information, and the event information may be displayed in the data table display region 360.

The user then edits the data table displayed in the data table display region 360, thereby making it possible to edit the content information including the position information, the virtual object information, or the event information. In addition, details edited with use of the data table are automatically reflected in another screen described above. For example, in a case where the user edits the latitude information or the longitude information of the virtual object in the data table, the position of the virtual object in the map display region 320 in FIG. 6 is changed to a position corresponding to the edited latitude information or the edited longitude information.

It should be noted that the GUI screen provided to the client 200 by the content creation control unit 114 is not limited to the GUI screens illustrated in FIGS. 6 to 10.

The content creation control unit 114 then determines a format, a size, security settings, and the (for example, access rights, and the like) of the content information, and performs integration and packaging of the position information, the virtual object information, the event information, and the like to create content information included in the AR content or the VR content. It should be noted that the content creation control unit 114 stores, in the storage unit 140, the created content information being added to the map information representing real space. This makes it possible to properly execute the content on the basis of the map information representing real space.

### Content Provision Unit 120

The content provision unit 120 is a functional configuration that provides the client 200 with the AR content or the VR content. As illustrated in FIG. 5, the content provision unit 120 includes an acquisition unit 121, a route determination unit 122, and a content provision control unit 123.

The acquisition unit 121 is a functional configuration that acquires any information used for provision of the AR content or the VR content. For example, the acquisition unit 121 acquires content information (which may be either content information regarding the AR content or content information regarding the VR content) created by the content creation unit 110 and stored in the storage unit 140.

In addition, the acquisition unit 121 acquires information indicating a status (or a state) of the user (hereinafter referred to as “user status information”). For example, the client 200 estimates a posture, a line of sight, speech, a position, an action, or the like of the user wearing a device of the client 200 with use of various sensors provided in the device of the client 200, generates the user status information on the basis of a result of such estimation, and provides the server 100 with the user status information. It should be noted that details of the user status information are not limited thereto, and may include any information as long as the information relates to the status (or state) of the user that is allowed to be outputted on the basis of a sensor or the like. In addition, the user status information may include details of an input performed by the user with use of an inputting means included in the client 200.

In addition, the acquisition unit 121 also acquires an action log of the user. The action log include, for example, a history of the position information of the user. Additionally, the action log may include an image acquired with an action of the user, a context of an action of the user, and the like. Users providing the acquisition unit 121 with the action log here may include one or a plurality of users different from a user using the AR content or the VR content. In addition, the acquisition unit 121 also acquires property information that is some information regarding the client 200. The property information includes product information, setting information, or the like of the client 200. In addition, a method of acquiring these pieces of information is not specifically limited. For example, the acquisition unit 121 may acquire these pieces of information from the client 200 via the communication unit 130.

The acquisition unit 121 then provides the route determination unit 122 and the content provision control unit 123 with these pieces of acquired information. This makes it possible for the route determination unit 122 to determine a route (for example, a recommended route) in the content on the basis of the position information, the action log, and the like of the user, and makes it possible for the content provision control unit 123 to control provision of the content on the basis of these pieces of information.

The route determination unit 122 is a functional configuration that determines a route (for example, a recommended route) in the AR content or the VR content. More specifically, the route determination unit 122 determines a route in the content on the basis of details of the content provided to the user, the position information included in the user status information acquired by the acquisition unit 121, and the like. For example, in a case where the AR content is provided, the route determination unit 122 outputs the shortest route from a current position of the user in real space to a next destination position in the AR content (for example, a position where an event occurs, and the like). In addition, in a case where the VR content is provided, the route determination unit 122 outputs the shortest route from a current position of the user in virtual space to a next destination position in the VR content. It should be noted that a method of outputting the route is not specifically limited.

In addition, the information used for determination of the route is not limited to the above. For example, the route determination unit 122 may also determine a route on the basis of the action log and the like. This allows the route determination unit 122 to determine a more appropriate route also on the basis of past actions of the user. For example, the route determination unit 122 may determine a route through which the user frequently passes as a route in the content, or conversely, may determine a route through which the user has not passed before as a route in the content. The route determination unit 122 provides the content provision control unit 123 with information indicating the determined route (hereinafter referred to as “route information”).

The content provision control unit 123 is a functional configuration that functioning as a first control unit that controls provision of the VR content and a second control unit that controls provision of the AR content. More specifically, the content provision control unit 123 controls provision of the AR content or the VR content on the basis of the user status information (including the position information) acquired by the acquisition unit 121, the route information outputted by the route determination unit 122, and the like.

For example, the content provision control unit 123 determines whether to provide the AR content or the VR on the basis of the position information of the user in real space included in the user status information and the property information of the client 200. For example, in a case where the position information of the user indicates “home” and the property information of the client 200 indicates “stationary terminal (non-AR compatible terminal)”, the content provision control unit 123 provides the client 200 with the VR content. In addition, in a case where the position information of the user indicates a specific position in real space and the property information of the client 200 indicates “AR-compatible terminal”, the content provision control unit 123 provides the client 200 with the AR content. It should be noted that the above description is merely an example, and a method of controlling provision of contents by the content provision control unit 123 may be changed as appropriate. For example, the content provision control unit 123 may determine whether to provide the AR content or the VR content on the basis of the action log and the like.

In addition, the content provision control unit 123 is also able to suggest a content. For example, the content provision control unit 123 may suggest one or a plurality of contents provided at a position where the user has been before (or a position close to that position) on the basis of a history of the position information of the user included in the action log. The content provision control unit 123 then provides the user with a content selected by the user from a plurality of suggested contents.

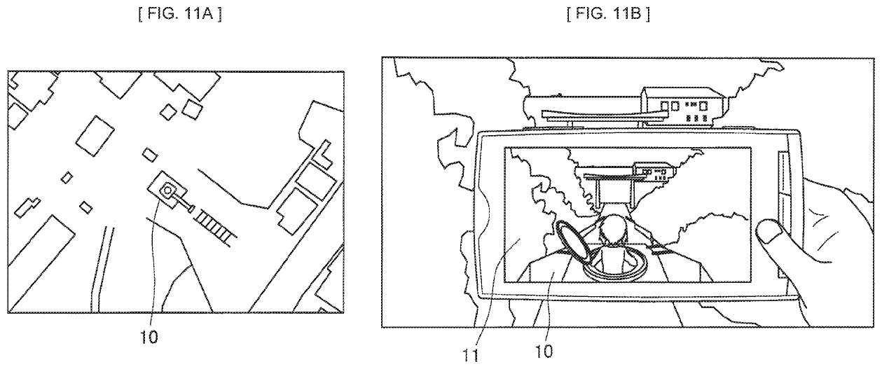

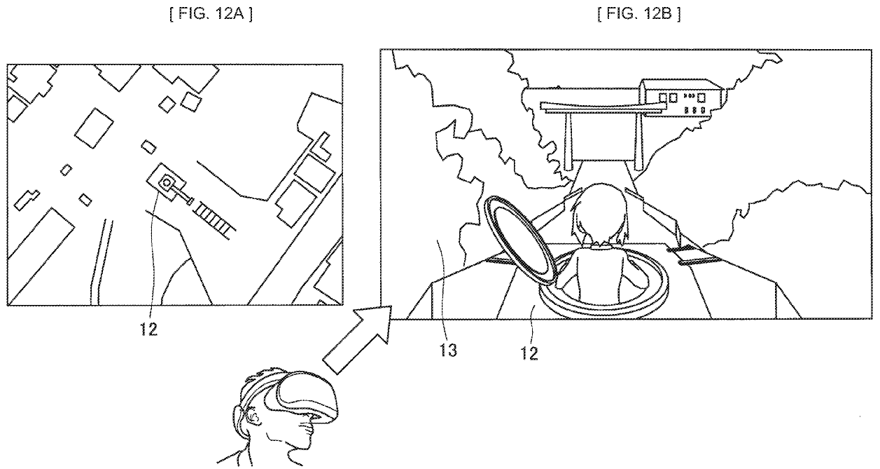

Hereinafter, display examples of the AR content and the VR content provided by the content provision control unit 123 are described with reference to FIGS. 11 and 12. FIG. 11 is a display example of the client 200 in a case where the content provision control unit 123 provides the AR content. In FIG. 11, 11B illustrates a display example of the client 200 in a case where the user directs the client 200 toward the front of a virtual object 10 in a state in which the user is located at a position in real space where the virtual object 10 that is a tank is placed as illustrated in 11A (it should be noted that, in the example in FIG. 11, the client 200 is the smartphone 203). At this time, the content provision control unit 123 displays the virtual object 10 on the client 200 to superimpose the virtual object 10 on an image in real space (background 11).

FIG. 12 is a display example of the client 200 in a case where the content provision control unit 123 provides the VR content. In FIG. 12, 12B illustrates a display example of the client 200 in a case where the user is directed toward the front of a virtual object 12 in a state in which the user is located at a position in virtual space corresponding to a position in real space where the virtual object 12 that is the tank is placed as illustrated in 12A (it should be noted that, in the example in FIG. 12, the client 200 is the occlusive HMD 202). At this time, the content provision control unit 123 displays the virtual object 12 on the client 200 to superimpose the virtual object 12 on an image in virtual space (background image 13) that is visible in a first-person view. It should be noted that the background image 13 is an image corresponding to real space. In other words, the background image 13 is an image that reproduces an image in real space, and may be an omnidirectional image or a free viewpoint image. For example, an omnidirectional image captured within a predetermined distance from a position (a latitude and a longitude) of the virtual object may be retrieved from a network, and the extracted omnidirectional image may be used as the background image 13. In addition, a tone of the placed virtual object may be analyzed, and a tone of the omnidirectional image may be adjusted on the basis of a result of such analysis. For example, in a case where an animated virtual object is displayed, an omnidirectional image used as the background image 13 may also be processed into an animated image. Display modes of the AR content and the VR content provided by the content provision control unit 123 are not limited to those in FIGS. 11 and 12.

In addition, the content provision control unit 123 may provide the client 200 with not only image information of the virtual object but also sound image information of the virtual object included in the content information. For example, in regard to the AR content, the content provision control unit 123 may output, to the client 200, the sound image information at a position in real space corresponding to the position information of the virtual object in real space. In addition, in regard to the VR content, the content provision control unit 123 may output, to the client 200, the sound image information at a position in virtual space corresponding to the position information of the virtual object in real space. It should be noted that the content provision control unit 123 may output only the sound image information to the client 200, or may output both the image information and the sound image information to the client 200.

### Communication Unit 130

The communication unit 130 is a functional configuration that controls various communications with the client 200. For example, for creation of the AR content or the VR content, the communication unit 130 transmits GUI screen information used for various settings to the client 200, and receives input information and the like from the client 200. In addition, for provision of the AR content or the VR content, the communication unit 130 receives the user status information (including the position information and the like) or the property information of the client 200 from the client 200, and transmits content information to the client 200. It should be noted that the information communicated by the communication unit 130 and a case where the communication unit 130 performs communication are not limited thereto.

### Storage Unit 140

The storage unit 140 is a functional configuration that stores various types of information. For example, the storage unit 140 stores the position information generated by the position processing unit 111, the virtual object information generated by the object processing unit 112, the event information generated by the event processing unit 113, the content information generated by the content creation control unit 114, various types of information acquired by the acquisition unit 121 (for example, the user status information, the action log, the property information of the client 200, or the like), the route information determined by the route determination unit 122, the content information provided to the client 200 by the content provision control unit 123, or the like. In addition, the storage unit 140 stores a program, a parameter, or the like used by each of the functional configurations of the server 100. It should be noted that details of information stored in the storage unit 140 are not limited thereto.

The functional configuration examples of the server 100 have been described above. The functional configurations described above with reference to FIG. 5 are merely examples, and the functional configurations of the server 100 are not limited thereto. For example, the server 100 may not necessarily include all of the configurations illustrated in FIG. 5. In addition, the functional configurations of the server 100 are flexibly changeable in accordance with specifications and operations.

### 1.4. Functional Configuration Example of Client 200

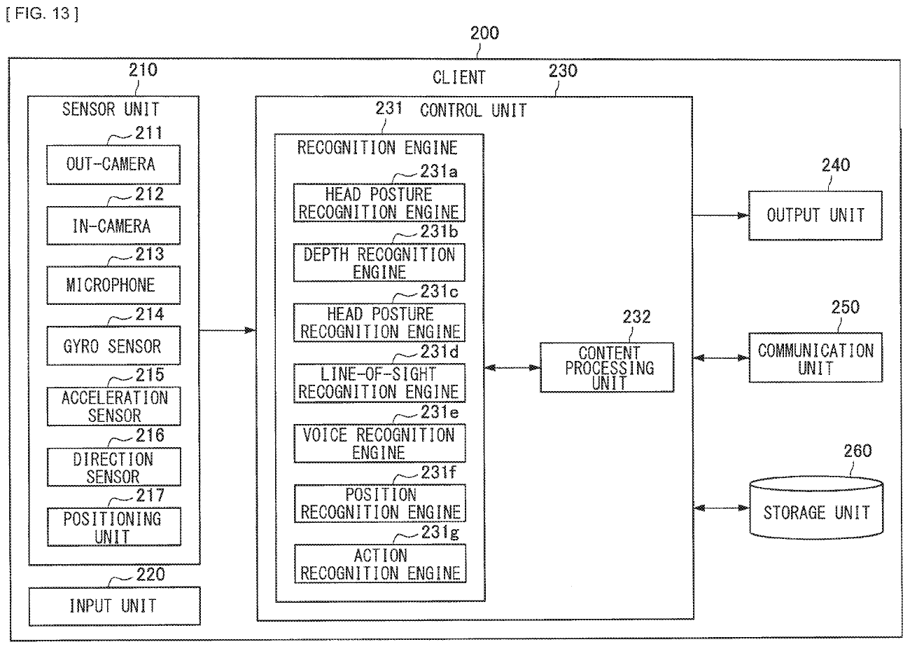

The functional configuration examples of the server 100 have been described above. Next, a functional configuration example of the client 200 is described with reference to FIG. 13. FIG. 13 is a functional configuration example assuming the optical see-through HMD 201 that executes the AR content and the occlusive HMD 202 that executes the VR content. It should be noted that in a case where the client 200 is other than the optical see-through HMD 201 or the occlusive HMD 202, a functional configuration may be added or removed as appropriate.

As illustrated in FIG. 13, the client 200 includes a sensor unit 210, an input unit 220, a control unit 230, an output unit 240, a communication unit 250, and a storage unit 260.

### Control Unit 230

The control unit 230 functions as an operation processing device and a control device, and controls all operations in the client 200 in accordance with various types of programs. The control unit 230 is configured, for example, with use of an electronic circuit such as a CPU (Central Processing Unit) or a microprocessor. In addition, the control unit 230 may include a ROM (Read Only Memory) that stores a program, an operation parameter, and the like to be used, and a RAM (Random Access Memory) that temporarily stores a parameter and the like that vary as appropriate.

In addition, as illustrated in FIG. 13, the control unit 230 according to the present embodiment includes a recognition engine 231 and a content processing unit 232. The recognition engine 231 has a function of recognizing various types of statuses of the user or a periphery with use of various types of sensor information sensed by the sensor unit 210. More specifically, the recognition engine 231 includes a head posture recognition engine 231a, a Depth recognition engine 231b, a SLAM (Simultaneous Localization and Mapping) recognition engine 231c, a line-of-sight recognition engine 231d, a voice recognition engine 231e, a position recognition engine 231f, and an action recognition engine 231g. These recognition engines illustrated in FIG. 13 are examples, and the present embodiment is not limited thereto.

The head posture recognition engine 231a recognizes the posture of the head of the user (including orientation or inclination of a face with respect to a body) with use of various types of sensor information sensed by the sensor unit 210. For example, the head posture recognition engine 231a may analyze at least one of a captured image of a periphery captured by an out-camera 211, gyroscopic information acquired by a gyro sensor 214, acceleration information acquired by an acceleration sensor 215, or direction information acquired by a direction sensor 216 to recognize the posture of the head of the user. It should be noted that a generally known algorithm may be used as a head posture recognition algorithm, and the algorithm is not specifically limited in the present embodiment.

The Depth recognition engine 231b recognizes depth information in space around the user with use of various types of sensor information sensed by the sensor unit 210. For example, the Depth recognition engine 231b may analyze the captured image of the periphery captured by the out-camera 211 to recognize distance information of an object in peripheral space and a plane position of the object. It should be noted that a generally known algorithm may be used as a Depth recognition algorithm, and the algorithm is not specifically limited in the present embodiment.

The SLAM recognition engine 231c may simultaneously perform self-position estimation and peripheral space mapping with use of various types of sensor information sensed by the sensor unit 210 to identify a self-position in peripheral space. For example, the SLAM recognition engine 231c may analyze the captured image of the periphery captured by the out-camera 211 to identify the self-position of the client 200. It should be noted that a generally known algorithm may be used as a SLAM recognition algorithm, and the algorithm is not specifically limited in the present embodiment.

It should be noted that the recognition engine 231 is allowed to perform spatial recognition (spatial comprehension) on the basis of a result of recognition by the above-described Depth recognition engine 231b and a result of recognition result by the above-described SLAM recognition engine 231c. Specifically, the recognition engine 231 is allowed to recognize the position of the client 200 in three-dimensional peripheral space.

The line-of-sight recognition engine 231d detects the line of sight of the user with use of various types of sensor information sensed by the sensor unit 210. For example, the line-of-sight recognition engine 231d analyzes a captured image of an eye of the user captured by an in-camera 212 to recognize the line of sight of the user. It should be noted that a line-of-sight detection algorithm is not specifically limited, but the line-of-sight direction of the user may be recognized on the basis of, for example, a positional relationship between the inner corner and the iris of an eye, or a positional relationship between corneal reflex and a pupil.

The voice recognition engine 231e recognizes a user or an environmental sound with use of various types of sensor information sensed by the sensor unit 210. For example, the voice recognition engine 231e may perform noise removal, sound source separation, and the like on collected sound information acquired by a microphone 213 to perform voice recognition, morphological analysis, sound source recognition, recognition of a noise level, or the like.

The position recognition engine 231f recognizes an absolute position of the client 200 with use of various types of sensor information sensed by the sensor unit 210. For example, the position recognition engine 231f recognizes a place of the client 200 (for example, a station, a school, home, an office, a train, an amusement park, and the like) on the basis of position information measured by a positioning unit 217 and map information acquired in advance.

The action recognition engine 231g recognizes an action of the user with use of various types of sensor information sensed by the sensor unit 210. For example, the action recognition engine 231g recognizes an action status (an example of an action state) of the user with use of at least one of a captured image of the out-camera 211, a collected sound of the microphone 213, angular velocity information of the gyro sensor 214, acceleration information of the acceleration sensor 215, direction information of the direction sensor 216, or absolute position information of the positioning unit 217. Examples of the action status of the user that may be recognized include a stationary state, a walking state (slow walking or jogging), a running state (dashing or high-speed running), a sitting state, a standing state, a sleeping state, a state of riding on a bicycle, a state of riding on a train, or a state of riding on an automobile. In addition, more specifically, the action recognition engine 231g may recognize a state and a status in accordance with an action amount measured on the basis of angular velocity information and acceleration information.

The content processing unit 232 is a functional configuration that executes processing related to the AR content or the VR content. More specifically, the content processing unit 232 performs processing related to creation of the contents or reproduction of the contents.

More specific description at the time of creation of the contents is given below. In a case where the user performs an input with use of the input unit 220 (for example, an input to a GUI screen provided by the server 100), the content processing unit 232 acquires input information from the input unit 220 and provides the server 100 with the input information.

More specific description at the time of reproduction of the contents is given below. The content processing unit 232 generates user status information that indicates the status (or state) of the user recognized by the above-described recognition engine 231, and provides the server 100 with the user status information. Thereafter, in a case where the server 100 provides content information about the AR content or the VR content on the basis of the user status information and the like, the content processing unit 232 outputs the content information by controlling the output unit 240. For example, the content processing unit 232 displays a virtual object on a display or the like, and outputs a sound image to a speaker or the like.

### Sensor Unit 210

The sensor unit 210 has a function of acquiring various types of information regarding the user or a surrounding environment. For example, the sensor unit 210 includes the out-camera 211, the in-camera 212, the microphone 213, the gyro sensor 214, the acceleration sensor 215, the direction sensor 216, and the positioning unit 217. It should be noted that a specific example of the sensor unit 210 described here is merely an example, and the present embodiment is not limited thereto. In addition, the numbers of the respective sensors may be plural.

Each of the out-camera 211 and the in-camera 212 includes a lens system including an imaging lens, an aperture, a zoom lens, a focus lens, and the like, a drive system that causes the lens system to perform a focusing operation or a zooming operation, a solid-state imaging element array that photoelectrically converts imaging light captured by the lens system to generate an imaging signal, and the like. The solid-state imaging element array may be configured, for example, with the use of a CCD (Charge Coupled Device) sensor array or a CMOS (Complementary Metal Oxide Semiconductor) sensor array.

The microphone 213 collects voice of the user and surrounding environmental sounds, and outputs them to the control unit 230 as voice information.

The gyro sensor 214 is configured, for example, with use of a three-axis gyro sensor, and detects angular velocity (rotational speed).

The acceleration sensor 215 is configured, for example, with use of a three-axis acceleration sensor (also referred to as a G sensor), and detects acceleration during movement.

The direction sensor 216 is configured, for example, with use of a three-axis geomagnetic sensor (compass), and detects an absolute direction (direction).

The positioning unit 217 has a function of detecting a current position of the client 200 on the basis of a signal acquired from outside. Specifically, the positioning unit 217 is configured, for example, with use of a GPS (Global Positioning System) positioning unit, and receives radio waves from GPS satellites, detects a position where the client 200 exists, and outputs the detected position information to the control unit 230. In addition, the positioning unit 217 may detect a position by, for example, Wi-Fi (registered trademark), Bluetooth (registered trademark), transmission and reception with a mobile phone, a PHS, a smartphone, or the like, short-range communication, or the like, in addition to the GPS. In addition, the positioning unit 217 may specify the position of the client 200 indirectly by recognizing bar code information or the like (for example, a QR code or the like) manually installed in advance. In addition, the positioning unit 217 may specify the position of the client 200 by recording images at various points in real space in advance on a database and matching characteristic points of these images with a characteristic point of an image captured by the out-camera 211 or the like.

### Input Unit 220

The input unit 220 is configured with use of an operation member having a physical structure such as a switch, a button, or a lever.

### Output Unit 240

The output unit 240 is a functional configuration that outputs various types of information. For example, the output unit 240 includes a display means such as a display or an audio output means such as a speaker, and output content information on the basis of control by the control unit 230. It should be noted that the output means of the output unit 240 is not specifically limited.

### Communication Unit 250

The communication unit 250 is a functional configuration that controls various communications with the server 100. For example, for creation of the AR content or the VR content, the communication unit 250 receives GUI screen information used for various settings from the server 100, and transmits input information and the like to the server 100. In addition, for reproduction of the AR content or the VR content, the communication unit 250 transmits the user status information (including the position information or the like), the property information of the device of the client 200, or the like to the server 100, and receives the content information from the server 100. It should be noted that the information communicated by the communication unit 250 and a case where the communication unit 250 performs communication are not limited thereto.

### Storage Unit 260

The storage unit 260 is a functional configuration that stores various types of information. For example, the storage unit 260 stores the property information of the device of the client 200, the user status information generated by the content processing unit 232, the content information provided from the server 100, or the like. In addition, the storage unit 260 stores a program, a parameter, or the like used by each of the functional configurations of the client 200. It should be noted that details of information stored in the storage unit 260 are not limited thereto.

The functional configuration examples of the client 200 have been described above. The functional configurations described above with reference to FIG. 13 are merely examples, and the functional configurations of the client 200 are not limited thereto. For example, the client 200 may not necessarily include all of the functional configurations illustrated in FIG. 13. In addition, the functional configurations of the client 200 are flexibly changeable in accordance with specifications and operations.

### 1.5. Example of Processing Flow

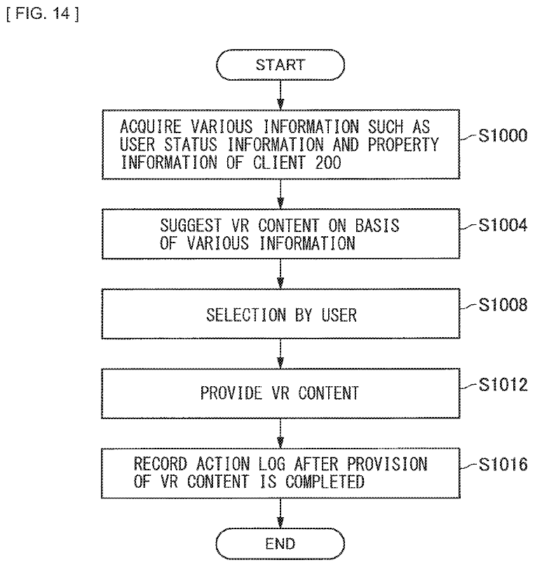

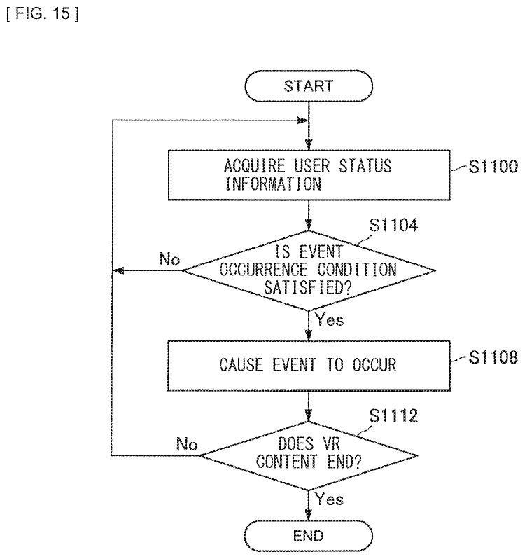

The functional configuration examples of the client 200 have been described above. Next, an example of a processing flow related to provision of a content are described with reference to FIGS. 14 and 15.

FIG. 14 is an example of a processing flow related to provision of the VR content by the server 100. In step S1000, the acquisition unit 121 of the server 100 acquires, from the client 200, various types of information including the user status information (including the position information) and the property information of the client 200. In step S1004, the content provision control unit 123 suggests one or a plurality of VR contents on the basis of the various types of information acquired. For example, in a case where the position information included in the user status information indicates “home” and the property information of the client 200 indicates “stationary terminal (non-AR compatible terminal)”, the content provision control unit 123 suggests one or a plurality of VR contents to the user. In addition, the content provision control unit 123 suggests one or a plurality of VR contents to the user on the basis of a position or the like where the user has been before on the basis of the action log or the like.

In step S1008, the user uses the input unit 220 of the client 200 to select a desired VR content from the suggested VR contents (if there is one suggested VR content, the user performs an input to select whether or not to play the VR content). In step S1012, the content provision control unit 123 of the server 100 provides the VR content selected by the user (a more detailed processing flow related to provision of the VR content is described with reference to FIG. 15). In a case where the provision of the VR content is completed, the acquisition unit 121 acquires the action log from the client 200 and stores the action log in the storage unit 140 in step S1016. Thus, the whole processing is completed.

FIG. 15 illustrates a process of providing the VR content to be performed in the step S1012 of FIG. 14 in more detail. In step S1100, the acquisition unit 121 of the server 100 continuously acquires the user status information (including the position information). It should be noted that frequency, a timing, or the like at which the acquisition unit 121 acquires the user status information during the provision of the content is not specifically limited.

The content provision control unit 123 then checks whether or not an event occurrence condition in the VR content is satisfied on the basis of the user status information. In a case where the event occurrence condition is satisfied (step S1104/Yes), the content provision control unit 123 causes an event to occur in the VR content in step S1108.

In step S1112, the content provision control unit 123 checks whether or not the VR content ends, and in a case where the VR content does not end (step S1112/No), processes of steps S1100 to S1108 are continuously executed. In a case where the VR content ends (S1112/Yes), the process of providing the VR content is completed.

It should be noted that the respective steps in the flowcharts illustrated in FIGS. 14 and 15 are not necessarily processed in the described chronological order. That is, the respective steps in the flowcharts may be processed in order different from the described order, or may be processed in parallel.

### 1.6. Hardware Configuration Example

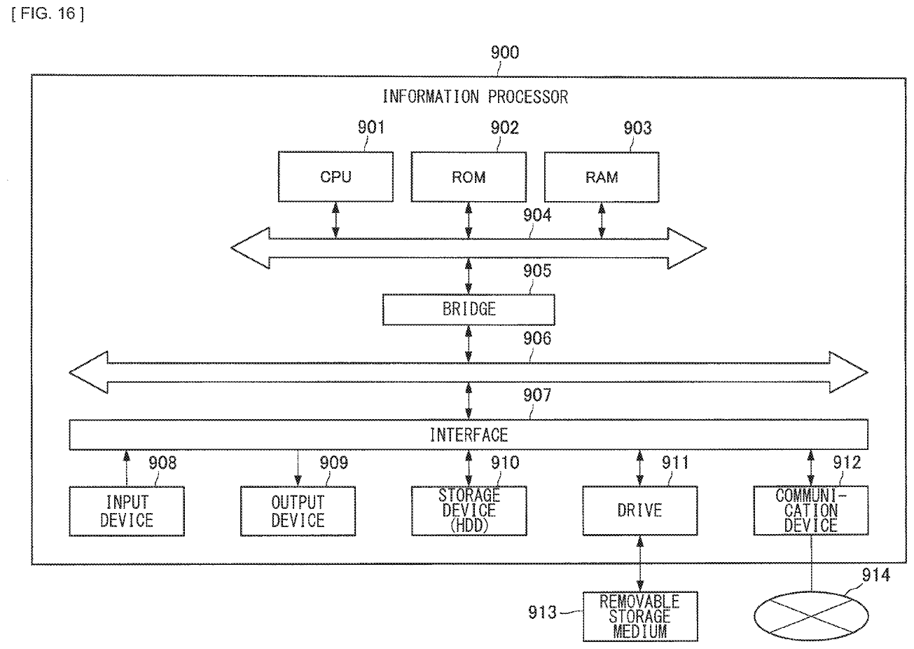

The example of the processing flow related to provision of the content has been described above. Next, a hardware configuration example of the server 100 or the client 200 is described with reference to FIG. 16.

FIG. 16 is a block diagram illustrating a hardware configuration example of an information processor 900 that embodies the server 100 or the client 200. The information processor 900 includes a CPU (Central Processing Unit) 901, a ROM (Read Only Memory) 902, a RAM (Random Access Memory) 903, a host bus 904, a bridge 905, an external bus 906, an interface 907, an input device 908, an output device 909, a storage device (HDD) 910, a drive 911, and a communication device 912.

The CPU 901 functions as an operation processing device and a control device, and controls all operations in the information processor 900 in accordance with various types of programs. In addition, the CPU 901 may be a microprocessor. The ROM 902 stores a program, an operation parameter, and the like to be used by the CPU 901. The RAM 903 temporarily stores a program to be used in execution of the CPU 901, a parameter appropriately changed in the execution, and the like. These components are coupled to each other by the host bus 904 including a CPU bus and the like. Functions of the content creation unit 110 or the content provision unit 120 of the server 100, or the sensor unit 210 or the control unit 230 of the client 200 are achieved by cooperation of the CPU 901, the ROM 902 and the RAM 903.

The host bus 904 is coupled to an external bus 906 such as a PCI (Peripheral Component Interconnect/Interface) bus via the bridge 905. It should be noted that the host bus 904, the bridge 905, and the external bus 906 are not necessarily configured separately, and functions thereof may be implemented in one bus.

The input device 908 includes input means, such as a mouse, a keyboard, a touch panel, a button, a microphone, a switch, and a lever, for the user to input information, an input control circuit that generates an input signal on the basis of an input by the user and outputs the generated input signal to the CPU 901, and the like. The user using the information processor 900 operates the input device 908, thereby making it possible to input various types of data to each device and instruct each device to perform a processing operation. The input device 908 implements functions of the input unit 220 of the client 200.

The output device 909 includes, for example, a display device such as a CRT (Cathode Ray Tube) display device, a liquid crystal display (LCD) device, an OLED (Organic Light Emitting Diode) device, and a lamp. The output device 909 further includes an audio output device such as a speaker and headphones. The output device 909 outputs a reproduced content, for example. Specifically, the display device displays various types of information such as a reproduced image data in text or images. Meanwhile, the audio output device converts reproduced audio data and the like into voice and outputs the voice. The output device 909 implements functions of the output unit 240 of the client 200.

The storage device 910 is a device for storing data. The storage device 910 may include a storage medium, a recording device that records data in the storage medium, a reading device that reads data from the storage medium, a deleting device that deletes data recorded in the storage medium, and the like. The storage device 910 includes, for example, a HDD (Hard Disk Drive). The storage device 910 drives a hard disk and stores programs and various types of data to be executed by the CPU 901. The storage device 910 implements functions of the storage unit 140 of the server 100 or the storage unit 260 of the client 200.

The drive 911 is a reader/writer for a storage medium, and is incorporated in or externally attached to the information processor 900. The drive 911 reads information recorded on a removable storage medium 913 such as a magnetic disk, an optical disk, a magneto-optical disk, or a semiconductor memory, and outputs the read information to the RAM 903. In addition, the drive 911 may write information to the removable storage medium 913.

The communication device 912 is, for example, a communication interface including a communication device and the like for coupling to a communication network 914. The communication device 912 implements functions of the communication unit 130 of the server 100 or the communication unit 250 of the client 200.

### 2. Examples

One embodiment of the present disclosure has been described above. Although main examples related to provision of contents have been described above, the server 100 is allowed to provide contents in various modes other than the above-described mode. Various examples about variations in provision of contents by the server 100 are described below.

### 2.1. First Example

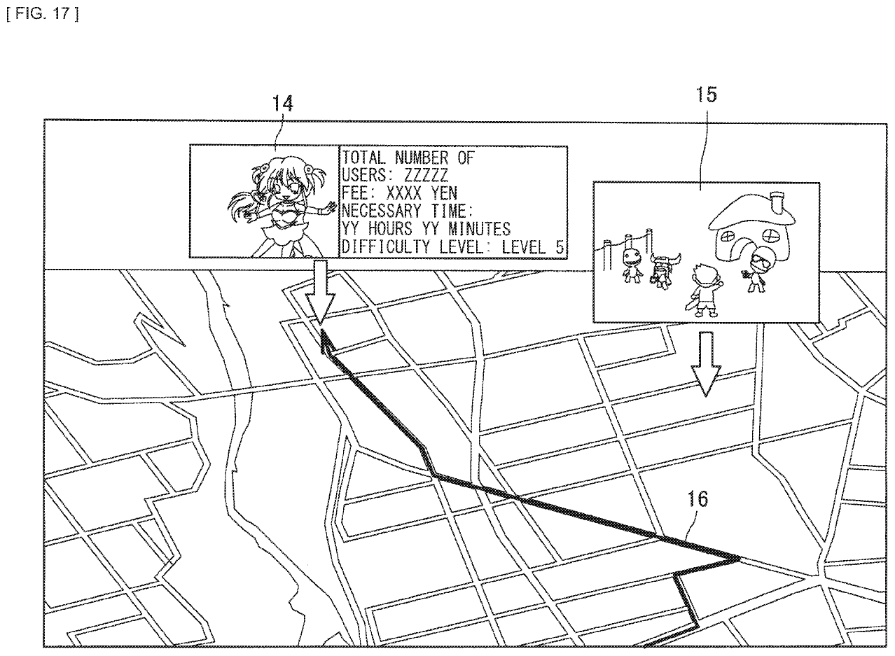

For example, in a case where the user uses the client 200 such as the occlusive HMD 202, the acquisition unit 121 of the server 100 acquires the user status information, the action log, or the like. Then, as described above, the content provision control unit 123 is able to suggest VR contents on the basis of the position information included in the user status information and the action log. At this time, as illustrated in FIG. 17, the content provision control unit 123 is able to display a position where each of the suggested VR contents is provided as a POI (Point of Interest) in a bird's-eye view (bird's view) of a map of virtual space corresponding to real space (in the example of FIG. 17, a POI 14 and a POI 15 are displayed).

At this time, the content provision control unit 123 may also display an image indicating details of the VR content (for example, a poster image of the VR content or an image indicating one scene of the VR content) similarly to the POI 15. In addition, the content provision control unit 123 may display information other than an image indicating details of the VR content similarly to the POI 14. For example, in an example of the POI 14, “TOTAL NUMBER OF USERS”, “FEE”, “NECESSARY TIME” and “DIFFICULTY LEVEL” are displayed. The “TOTAL NUMBER OF USERS” indicates the total number of users playing a VR content corresponding to the POI 14 at the time of display, the “FEE” indicates a play charge of the VR content, the “NECESSARY TIME” indicates time necessary from the start to the end of the VR content (or an average value of the time necessary from the start to the end), and the “DIFFICULTY LEVEL” indicates a difficulty level of the VR content. It should be noted that information displayed on the POI is not limited to the above.

The user selects a VR content to be played by a predetermined method (for example, an input to the input unit 220 of the client 200, a gesture or a gaze of the content in a state in which the client 200 is worn, and the like). Thereafter, the route determination unit 122 of the server 100 outputs a recommended route 16 from a current position in virtual space (or a position selected by the user by a predetermined method) to a position where the selected VR content is provided, and the content provision control unit 123 displays the recommended route 16 on the client 200. It should be noted that the content provision control unit 123 may provide, for example, advertisement information of a shop, an event, and the like on the recommended route 16 in real space.

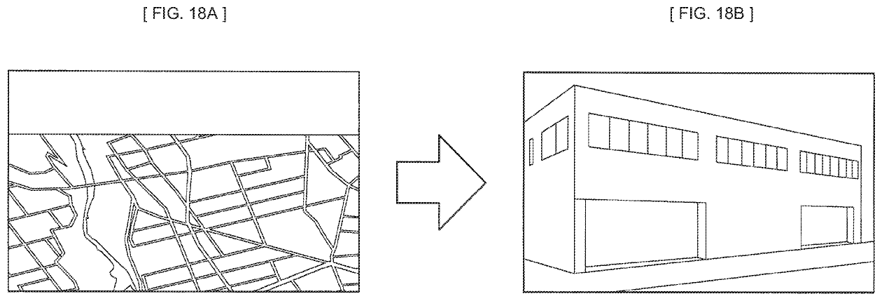

In a case where the user moves along the recommended route 16 in virtual space, the content provision control unit 123 displays an omnidirectional image (for example, an omnidirectional image in which real space is reproduced) corresponding to the position of the user in virtual space illustrated in 18B of a bird-eye view (bird view) of a map illustrated in 18A of FIG. 18. More specifically, the content provision control unit 123 causes the client 200 to display an omnidirectional image corresponding to each position on the recommended route 16 on the basis of position information of the user in virtual space acquired from the client 200. At this time, the content provision control unit 123 may cause the client 200 to reproduce a hyperlapse moving image in which an omnidirectional image is continuously reproduced (in other words, may not cause the client 200 to reproduce a timelapse moving image) along with movement of the user along the recommended route 16. This allows the content provision control unit 123 to provide the user with smoother and more dynamic display. It should be noted that reproduction speed of the hyperlapse moving image may be appropriately adjusted by the user. In addition, the content provision control unit 123 may display a free viewpoint image instead of the omnidirectional image.

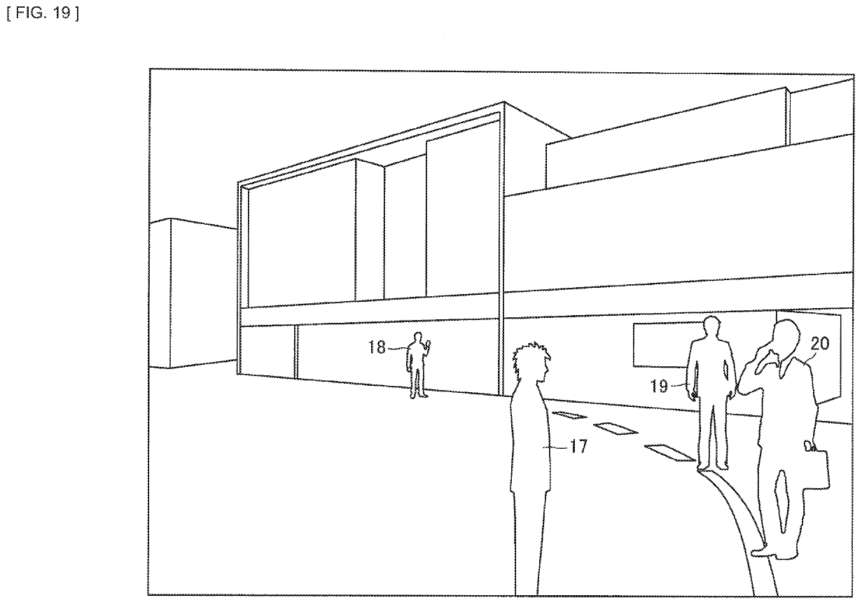

Thereafter, in a case where the user arrives at the position where the selected VR content is provided, and plays the VR content, as illustrated in FIG. 19, the content provision control unit 123 may cause a character 17 to be displayed as a virtual object. The content provision control unit 123 may then move the character 17 backward with respect to a screen in accordance with the progress of an event, thereby causing the user to recognize the route.

In addition, in a case where a plurality of users are playing the VR content simultaneously, the content provision control unit 123 may display avatars 18 to 20 representing other users on the basis of position information of the respective users. This allows the content provision control unit 123 to shows, to the user, how other users are playing the VR content. In addition, the content provision control unit 123 is allowed to present a bustle of the VR content, and the like. It should be noted that the content provision control unit 123 may display an avatar of a user who has played the VR content in the past (for example, within the last one week or less). In addition, the content provision control unit 123 may also adjust the number of avatars to be displayed on the basis of a congestion situation of avatars, and the like. In addition, the content provision control unit 123 may randomly select an image prepared in advance to display the image as an avatar, or may display an image inputted by the user as an avatar. The content provision control unit 123 may display an avatar on the client 200 that is playing the VR content on the basis of the position information of the client 200 that is playing (was playing) the AR content.

In addition, the content provision control unit 123 may cause each avatar to perform an action (for example, waving a hand or cocking a head at a quiz) according to a condition set in an event with which each user is proceeding. This allows the content provision control unit 123 to make the user feel a sense of reality of the VR content more specifically.

### 2.2. Example 2

A second example is an example related to a content (raid content) simultaneously playable by a plurality of users.

In present example, the content provision control unit 123 grasps a status (including a positional relationship) of each of users on the basis of user status information (including position information) from the clients 200 used by a plurality of users, thereby making it possible to reflect the status (including the positional relationship) of each of the users in an AR content or a VR content.

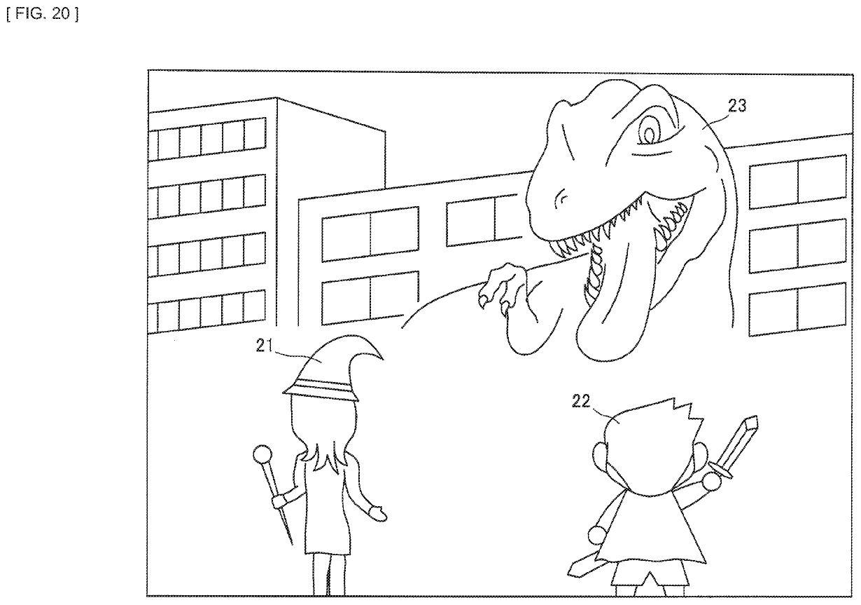

For example, as illustrated in FIG. 20, the content provision control unit 123 is able to simultaneously provide a user A and the user B with a content or the like in which an avatar 21 corresponding to the user A and an avatar 22 corresponding to the user B fight against a monster 23. The content provision control unit 123 is able to provide a high sense of reality and high entertainment to these users by occurrence of an event on the basis of the position information of the users A and B, sharing of a virtual object (for example, the monster 23, etc.), and the like.

Here, it is desirable that the behavior and the position of the monster 23 change in accordance with the position and the behavior of each of the users A and B, which change from moment to moment, from the viewpoint of a sense of immersion. To do so, it is necessary to transmit common content information processed on the server 100 in real time to the clients 200 of the user A and the user B on the basis of user status information (including position information) transmitted from the client 200 of the user A and user status information (including position information) transmitted from the client 200 of the user B.

However, the user status information of each of the users is acquired by a plurality of sensors included in each of the clients 200, and is transmitted to the server 100 at a communication speed that normally has an upper limit. For this reason, there is a possibility that the progress of the content is delayed. Further, there is a possibility that the degree of delay is different for each of the users.

Accordingly, the client 200 may solve this issue by performing not only communication with the server 100 but also short-range wireless communication such as Bluetooth with another client 200. For example, first, it is assumed that the client 200 of the user A acquires a current position of the monster 23 from the server 100. Position information of the monster 23 is also acquired in real time by the client 200 of the user B. The user A performs, for example, a gesture of waving a hand from right to left against the monster 23. The client 200 of the user A determines whether or not the monster 23 has been flicked off, without using the server 100 on the basis of user status information regarding the gesture of the user A and position information of the monster 23 acquired from the server 100. Then, the client 200 of the user A generates content information (or event information included in content information) that “the monster 23 has been flicked off” in accordance with a result of such determination.

The content information generated by the client 200 of the user A is transmitted to the server 100 by a predetermined communication system, and is transmitted to the client 200 of the user B by short-range wireless communication such as Bluetooth. This makes it possible for the client 200 of the user B to recognize occurrence of an event that “the monster 23 has been flicked off by the user A”.

Thereafter, the client 200 of the user B controls the behavior of the monster 23 on the basis of the content information. In other words, the client 200 of the user B is able to provide the user B with the event that “the monster 23 has been flicked off by the user A” without using the server 100.

The behavior and the position of the monster 23 processed without the server 100 are corrected in accordance with a result of processing by the server 100. At this time, to achieve reflection of actions by the user A and the user B in the content in as real time as possible, the server 100 may preferentially perform correction processing on a result of processing in the client 200 of the user A. For example, in a case where the user A makes a gesture, the position of the monster 23 changes in accordance with the position and the behavior of the user B, which may cause a case where the gesture of waving a hand from right to left by the user A does not hit the monster 23 under ordinary circumstances. Even in such a case, the server 100 may prioritize a result that “the monster 23 has been flicked off by the user A” processed by the client 200 of the user A, and may correct the progress of the event in accordance with the result. Specifically, the server 100 corrects the position of the monster 23 in the clients 200 of the user A and the user B on the precondition that “the monster 23 has been flicked off by the user A” to match the positions of the monster 23 in the clients 200 of the user A and the user B with each other.

This makes it possible to reflect the gesture by each of the user A and the user B in the content executed by each of the clients 200 with a less delay. In addition, as a result of consideration of sensor information of the respective clients 200, it is possible to prevent rewinding of the event such as correction from an event that the gesture (gesture of waving a hand from right to left) has hit the monster 23 to an event that the gesture has not hit the monster 23, and to suppress deterioration in usability.

### 2.3. Third Example

A third example is an example of real-time interaction between an AR content and a VR content.

A case considered is where a user A who is playing an AR content and a user B who is playing a VR content corresponding to the AR content at the same timing as that at which the user A is playing the AR content are present. In this case, the server 100 receives user status information (including position information) from the clients 200 used by the respective users, and grasps a status (including a positional relationship) of each of the users, thereby making it possible to reflect the status of each of the users in each of the AR content and the VR content.

This allows the server 100 to synchronize an event in the AR content being played by the user A with an event in the VR content being played by the user B, thereby making it possible to provide these users with a high sense of reality and high entertainment. For example, each of the users is allowed to cooperatively execute an event (for example, solving an issue, etc.).

In this case, the moving speed and the moving range of the user B who is playing the VR content are more limited than in a case where the VR content alone is reproduced without synchronizing an event with the AR content. More specifically, moving speed in virtual space is limited to about 4 to 10 [km] per hour to correspond to speed of moving on foot in real space. In addition, the moving range of the user B playing the VR content may be prohibited from walking in a middle of a road in virtual space, or the moving range may be limited not to allow for crossing a road without using a crosswalk.

The position of the user B playing the VR content in real space may be displayed on the client 200 of the user A playing the AR content. For example, in a case where the client 200 of the user A is a smartphone (or a see-through HMD), an angle of view of a camera of the smartphone is directed to a range where the user B is placed, thereby controlling display of the smartphone to superimpose an avatar representing the user B on an image in real space. Meanwhile, the position of the user A playing the AR content in real space may be displayed on the client 200 of the user B playing the VR content. The position of the user A in real space is detected, for example, by a GPS. In a case where the client 200 of the user B is an HMD, the HMD is directed to a range where the user A is placed, thereby controlling display of the HMD to superimpose an avatar representing the user A on an omnidirectional image, for example.

Incidentally, the position and orientation of the client 200 of the user A playing the AR content may be specified by a combination of various types of sensors such as a GPS and an acceleration sensor, and a gyro sensor. However, the various types of sensors each have a detection error, which may cause the position and orientation of the user A indicated by sensor values acquired by the various types of sensors to be different from the actual position and actual orientation of the user A. Accordingly, the position and orientation of the avatar representing the user A based on the sensor values on the client 200 of the user B may be different from the actual position and actual orientation of user A. As a result, the line of sight of the user A playing the AR content and the line of sight of the user B playing the VR content may deviate from each other unintentionally during communication.

In view of the above-described issue, in a case where it is estimated that communication is to be performed between the user B and the user A, for example, it is desirable to appropriately correct the line of sight of the user A in the client 200 of the user B. More specifically, in a case where it is estimated that an angle between a straight line joining the position of the user A and the position of the user B in real space and the orientation of the client 200 of the user A is decreasing, that is, the user A and the user B are about to directly face each other, the avatar representing the user A may be caused to directly face the user B in the client 200 of the user B even in a case where the sensor values acquired by the client 200 of the user A indicate that the user A does not directly face the user B. That is, the direction of the avatar is changed more greatly than in a case where it is estimated that communication is to be performed between the user B and the user A, than in a case where it is not estimated that communication is to be performed between the user B and the user A. Such directly facing display processing may be also executed similarly in the client 200 of the user A. This makes it possible to alleviate or eliminate a line-of-sight mismatch in communication between the user A and the user B.

### 2.4. Modification Example

In the above-described examples, the AR content and the VR content regarding the earth have been basically described, but the server 100 according to the present disclosure may be used for provision of a AR content and a VR content regarding outside of the earth. For example, a VR content may be created by associating a virtual object with a map of a surface of a celestial body such as the moon and Mars. Alternatively, a VR content may be created with use of a three-dimensional outer space map. Such an extraterrestrial content may be provided, for example, as training for astronauts or as a simulated space travel content by civilians. Alternatively, the content may be provided as an astronomical observation content available on the earth.

In the above-described examples, an example in which the user producing a content places a virtual object on map information as appropriate has been described. In general, in regard to an area such as a temple, a shrine, and a Buddhist temple, a highly dangerous area such as an area on a railway, or the like, it is desirable to receive an approval in advance for provision of an AR content in the area from an organization (or a manager) that manages the area. Accordingly, an AR content management organization related to a playing area may be searched through a network on the basis of setting of a playing area of each content by the user, and information regarding the approval based on a result of such search may be presented to the user on a GUI. Alternatively, a platform may be configured to automatically transmit an application for approval to the AR content management organization by e-mail or the like on the basis of the result of such search. In addition, in a case where the platform has not received the approval for provision of the content from the AR content management organization, the server 100 may be controlled to prohibit the provision of the AR content from the server 100 to the client 200. Meanwhile, provision of a produced VR content at least to the AR content management organization may be permitted for consideration of approval.

Through the platform in the present disclosure, 3D modelling of a specific real object may be performed with use of 2D images acquired by the clients 200 of a plurality of users. The respective users playing the AR content may receive an instruction (event) such as “next, photograph a stuffed toy”, for example. In response to this instruction, a plurality of 2D images that includes the stuffed toy photographed from different viewpoints and angles are transmitted from the clients 200 of the respective users to the server 100. The 2D images are different from each other. The server 100 is able to analyze characteristic points of the plurality of 2D images and generate a 3D virtual object of the stuffed toy. The server 100 is able to specify (limit) candidates of 2D images to be used for 3D modelling of a real object from many received 2D images on the basis of specific event information with which the clients 200 having transmitted 2D images are proceeding and position information of the clients 200. This makes it possible for the server 100 to efficiently reduce an analysis load on 3D modelling. The generated 3D virtual object provided with position information may be shared on the platform. Thus, the 3D virtual object usable for the AR content may be collected along with provision of the AR content. The collected 3D virtual object may optionally be provided as 3D virtual object displayed on the platform, for example, in a VR content. It should be noted that the collected 3D virtual object may be provided with property information of each user or the client 200 that is acquired from results of calculation by the clients 200 of a plurality of users who transmits 2D images with use of a block chain technology. This property information is used to calculate a contribution ratio of each user with respect to generation of the 3D virtual object as appropriate, and a reward may be paid to each user according to the calculated contribution ratio. Payment of the reward may be made, for example, by providing currency information including a virtual currency based on the block chain technology or by providing benefit data associated with the AR content.

### 3. Conclusion

As described above, the present disclosure makes it possible to provide a platform where a VR content is available with use of at least a portion of information used for provision of an AR content. More specifically, the server 100 according to the present disclosure is able to create the VR content with use of at least a portion of information used for provision of the AR content. Thereafter, the server 100 is able to provide the client 200 with the thus-created VR content. It should be noted that the server 100 is also able to create an AR content, and is also able to provide the client 200 with the thus-created AR content.

Thus, according to the present disclosure, making the user experience the VR content corresponding to the AR content makes it possible to raise a user's interest in the AR content that is originally experienceable only on-site and to more efficiently spread the AR content.

A preferred embodiment(s) of the present disclosure has/have been described above in detail with reference to the accompanying drawings, but the technical scope of the present disclosure is not limited to such an embodiment(s). A person skilled in the art may find various alterations and modifications within the scope of the appended claims, and it should be understood that they will naturally come under the technical scope of the present disclosure.

For example, apart from the context of the AR content and the VR content, there may be provided a system that is allowed to link a virtual object to real space (or any object in real space) by a predetermined operation (for example, a simple operation such as dragging and dropping) by a user and share the virtual object independently of the type of the client 200. This makes it possible to provide, for example, an experience in which a user drags and drops a virtual material (virtual object) to a vacant tenant with use of a GUI screen displayed on the client 200, and views the virtual object on the client 200 when the user (or another user) actually visits the vacant tenant.

It should be noted that as the virtual object, an object set as Creative Commons, a chargeable public object, an object limited only to a specific user, or the like linked with position information may be appropriately searched and used.

In addition, the effects described herein are merely illustrative and exemplary, and not limitative. That is, the technology according to the present disclosure may exert other effects that are apparent to those skilled in the art from the description herein, in addition to the above-described effects or in place of the above-described effects.

It should be noted that the following configurations are also fall within the technical scope of the present disclosure.

(1)

An information processor including:

an acquisition unit that acquires content information including image information of a virtual object and position information of the virtual object in real space, the content information to be added to map information representing the real space; and

a first control unit that displays, on the basis of the content information, the image information on a first client terminal at a position in virtual space corresponding to the position information to superimpose the image information on an image in the virtual space that is visible in a first-person view.

(2)

The information processor according to (1), in which the image in the virtual space includes an image corresponding to the real space based on a captured image in the real space.

(3)

The information processor according to (2), in which the first control unit displays, on the basis of position information regarding the map information of a second client terminal different from the first client terminal, an avatar corresponding to the second client terminal on the first client terminal to superimpose the avatar on the image in the virtual space.

(4)

The information processor according to (3), in which, on the basis of position information of the first client terminal regarding the map information, the first control unit changes orientation of the avatar more greatly in a case where it is estimated that communication is to be performed between a user of the first client terminal and a user of the second client terminal, the position information of the second client terminal, and posture information of the second client terminal, than in a case where it is estimated that the communication is not to be performed.

(5)

The information processor according to any one of (1) to (4), in which the content information further includes information regarding an event that is to be performed by the virtual object.

(6)

The information processor according to any of (1) to (5), in which

the content information further includes sound image information of the virtual object, and

the first control unit causes the sound image information to be outputted at a position in virtual space corresponding to the position information on the basis of the content information.

(7)

The information processor according to any one of (1) to (6), further including a second control unit that displays, on the basis of the content information, the image information at a position in the real space corresponding to the position information to superimpose the image information on the image in the real space.

(8)

The information processor according to any one of (1) to (7), further including a content creation unit that creates the content information on the basis of an input from a user.

(9)

The information processor according to (8), in which the content creation unit creates an AR (Augmented Reality) content and a VR (Virtual Reality) content corresponding to the AR content.

(10)

The information processor according to (9), in which the content creation unit creates the VR content with use of at least a portion of information used for creation of the AR content.

(11)

The information processor according to any one of (8) to (11), in which the content creation unit provides a user with a GUI screen used for the input.

(12)

The information processor according to (11), in which the content creation unit provides the user with an input screen for the image information, an input screen for the position information, or an input screen for information regarding an event to be performed by the virtual object as the GUI screen.

(13)

The information processor according to (12), in which

the content creation unit receives dragging operation information and dropping operation information for a virtual object by the user,

the content creation unit automatically adjusts a position of the virtual object on the basis of map information in a case where a combination of a property of the virtual object, a dropped position of the virtual object corresponding to the dragging operation information, and the map information corresponding to the dropped position satisfies a predetermined condition, and

the content creation unit sets the position of the virtual object to a dropped position by the user in a case where the combination does not satisfy the predetermined condition.

(14)

The information processor according to any one of (8) to (13), in which the content creation unit performs 3D modelling of a specific real object in the real space on the basis of a plurality of captured images acquired from a plurality of client terminals playing an AR content, content information of the AR content acquired from the plurality of client terminals, and position information regarding the map information of the plurality of client terminals.

(15)

An information processing method to be executed by a computer, the information processing method including:

acquiring content information including image information of a virtual object and position information of the virtual object in real space, the content information to be added to map information representing the real space; and

displaying, on the basis of the content information, the image information on a first client terminal at a position in virtual space corresponding to the position information to superimpose the image information on an image in the virtual space that is visible in a first-person view.

(16)

A program causing a computer to execute:

acquiring content information including image information of a virtual object and position information of the virtual object in real space, the content information to be added to map information representing the real space; and

displaying, on the basis of the content information, the image information on a first client terminal at a position in virtual space corresponding to the position information to superimpose the image information on an image in the virtual space that is visible in a first-person view.

### REFERENCE SIGNS LIST

100: server
110: content creation unit
111: position processing unit
112: object processing unit
113: event processing unit
114: content creation control unit
120: content provision unit
121: acquisition unit
122: route determination unit
123: content provision control unit
130: communication unit
140: storage unit
200: client
210: sensor unit
211: out-camera
212: in-camera
213: microphone
214: gyro sensor
215: acceleration sensor
216: direction sensor
217: positioning unit
220: input unit
230: control unit
231: recognition engine
231a: head posture recognition engine
231b: Depth recognition engine
231c: SLAM recognition engine
231d: line-of-sight recognition engine
231e: voice recognition engine
231f: position recognition engine
231g: action recognition engine
232: content processing unit
240: output unit
250: communication unit
260: storage unit

1. An information processor comprising:
an acquisition unit that acquires content information including image information of a virtual object and position information of the virtual object in real space, the content information to be added to map information representing the real space; and
a first control unit that displays, on a basis of the content information, the image information on a first client terminal at a position in virtual space corresponding to the position information to superimpose the image information on an image in the virtual space that is visible in a first-person view.

2. The information processor according to claim 1, wherein the image in the virtual space includes an image corresponding to the real space based on a captured image in the real space.

3. The information processor according to claim 2, wherein the first control unit displays, on a basis of position information regarding the map information of a second client terminal different from the first client terminal, an avatar corresponding to the second client terminal on the first client terminal to superimpose the avatar on the image in the virtual space.

4. The information processor according to claim 3, wherein, on a basis of position information of the first client terminal regarding the map information, the first control unit changes orientation of the avatar more greatly in a case where it is estimated that communication is to be performed between a user of the first client terminal and a user of the second client terminal, the position information of the second client terminal, and posture information of the second client terminal, than in a case where it is estimated that the communication is not to be performed.

5. The information processor according to claim 1, wherein the content information further includes information regarding an event that is to be performed by the virtual object.

6. The information processor according to claim 1, wherein
the content information further includes sound image information of the virtual object, and
the first control unit causes the sound image information to be outputted at a position in virtual space corresponding to the position information on a basis of the content information.

7. The information processor according to claim 1, further comprising a second control unit that displays, on a basis of the content information, the image information at a position in the real space corresponding to the position information to superimpose the image information on the image in the real space.

8. The information processor according to claim 1, further comprising a content creation unit that creates the content information on a basis of an input from a user.

9. The information processor according to claim 8, wherein the content creation unit creates an AR (Augmented Reality) content and a VR (Virtual Reality) content corresponding to the AR content.

10. The information processor according to claim 9, wherein the content creation unit creates the VR content with use of at least a portion of information used for creation of the AR content.

11. The information processor according to claim 8, wherein the content creation unit provides a user with a GUI screen used for the input.

12. The information processor according to claim 11, wherein the content creation unit provides the user with an input screen for the image information, an input screen for the position information, or an input screen for information regarding an event to be performed by the virtual object as the GUI screen.

13. The information processor according to claim 12, wherein
the content creation unit receives dragging operation information and dropping operation information for a virtual object by the user,
the content creation unit automatically adjusts a position of the virtual object on a basis of map information in a case where a combination of a property of the virtual object, a dropped position of the virtual object corresponding to the dragging operation information, and the map information corresponding to the dropped position satisfies a predetermined condition, and
the content creation unit sets the position of the virtual object to a dropped position by the user in a case where the combination does not satisfy the predetermined condition.

14. The information processor according to claim 8, wherein the content creation unit performs 3D modelling of a specific real object in the real space on a basis of a plurality of captured images acquired from a plurality of client terminals playing an AR content, content information of the AR content acquired from the plurality of client terminals, and position information regarding the map information of the plurality of client terminals.

15. An information processing method to be executed by a computer, the information processing method comprising:
acquiring content information including image information of a virtual object and position information of the virtual object in real space, the content information to be added to map information representing the real space; and
displaying, on a basis of the content information, the image information on a first client terminal at a position in virtual space corresponding to the position information to superimpose the image information on an image in the virtual space that is visible in a first-person view.

16. A program causing a computer to execute:
acquiring content information including image information of a virtual object and position information of the virtual object in real space, the content information to be added to map information representing the real space; and
displaying, on a basis of the content information, the image information on a first client terminal at a position in virtual space corresponding to the position information to superimpose the image information on an image in the virtual space that is visible in a first-person view.
